(19) United States
(12) Patent Application Publication
(10) Pub. No.: US 2026/0133029 A1
(43) Pub. Date: May 14, 2026

(54) ACOUSTIC-BASED CHARACTERIZATION OF CONTAINMENT STRUCTURES AND FLUID CONTENTS

(71) Applicant: Triad National Security, LLC, Los Alamos, NM (US)

(72) Inventors: Alp Tugrul FINDIKOGLU, Los Alamos, NM (US); Rajendra Prasath PALANISAMY, Los Alamos, NM (US)

(21) Appl. No.: 19/352,991

(22) Filed: Oct. 8, 2025

Related U.S. Application Data
(60) Provisional application No. 63/718,857, filed on Nov. 11, 2024.

(51) Int. Cl. G01B 17/02; G01K 3/02; G01K 11/24

(52) U.S. Cl. CPC G01B 17/02; G01K 3/02; G01K 11/24

(57) ABSTRACT

An example acoustic measurement system includes a container comprising a container wall structurally defining an internal cavity of the container, a process fluid disposed within the internal cavity, a first acoustic sensor coupled to an external surface of the container wall, and a second acoustic sensor coupled to the external surface of the container wall, the first and second acoustic sensors configured to emit ultrasonic waves according to different modalities, wherein, in operation, the system is configured to compensate for temperature in near real-time to acoustically determine container wall thickness measurements. In some embodiments, the second acoustic sensor is proximate the first acoustic sensor and in some further embodiments, a third acoustic sensor is coupled to the external surface of the container wall at a calculated distance from at least the second acoustic sensor. The second and third acoustic sensors may be configured to emit and receive acoustic waves, including bulk, interface, and/or guided waves, wherein, in operation, the system is configured to determined one or more physical properties of the process fluid in short-range.

### CROSS-REFERENCE TO RELATED APPLICATION(S)

The present application claims priority to and benefit of U.S. Provisional Application Ser. No. 63/718,857, titled “ACOUSTIC-BASED CHARACTERIZATION OF CONTAINMENT STRUCTURES AND FLUID CONTENTS”, filed Nov. 11, 2024, the entire contents of which are incorporated herein by reference.

### STATEMENT REGARDING GOVERNMENT SUPPORT

This invention was made with government support under 89233218CNA000001 awarded by the National Nuclear Security Administration. The government has certain rights in the invention.

### TECHNOLOGICAL FIELD

Example embodiments of the present disclosure relate generally to non-destructive evaluation techniques, and more particularly, to acoustic-based characterization of containment structures and fluid contents in high-temperature and/or high-radiation applications.

### BACKGROUND

Conventional acoustic container-wall and liquid-content characterization requires invasive techniques, direct contact with the liquid medium, access to the exact diametrically opposite side of the container, and/or temperature assumptions which may lead to large errors in measurements. The inventors have identified a number of deficiencies and problems in conventional mechanical and acoustic approaches for physical characterization of containment structures (e.g., vessels, containers, pipes, and the like) and their fluid contents. Through applied effort, ingenuity, and innovation, many of these identified deficiencies and problems have been solved by developing solutions that are structured in accordance with the embodiments of the present disclosure, many examples of which are described in detail herein.

### BRIEF SUMMARY

Various embodiments of the present disclosure are directed to acoustic measurement systems and methods for nondestructive characterization of container wall corrosion, wall-fluid interface characteristics, and process fluid physical properties (e.g., density, bulk modulus, and viscosity) in an acoustic measurement system. In accordance with some exemplary embodiments of the present disclosure, an acoustic measurement system includes a container comprising a container wall structurally defining an internal cavity of the container; a process fluid disposed within the internal cavity; a first acoustic sensor coupled to an external surface of the container wall; and a second acoustic sensor coupled to the external surface of the container wall, the first and second acoustic sensors configured to emit ultrasonic waves according to different modalities, wherein, in operation, the system is configured to compensate for temperature in near real-time to acoustically determine container wall thickness measurements.

In some embodiments, the second acoustic sensor is proximate the first acoustic sensor.

In some embodiments, the first acoustic sensor is a shear acoustic sensor configured to emit ultrasonic waves in a shear mode. In some further embodiments, the second acoustic sensor is a compressive acoustic sensor configured to emit ultrasonic waves in a compressive mode.

In some embodiments, a standoff is disposed between the wall and at least one of the first acoustic sensor and the second acoustic sensor.

In some embodiments, at least one of the first acoustic sensor and the second acoustic sensor comprises radiation shielding.

In some embodiments, the container is a flow pipe.

In some embodiments, the container is a vessel of irregular shape.

In some embodiments, the container comprises one or more internal components. In some further embodiments, the one or more internal components comprise at least one of a mixing element, wave breaker, splash plate, or sand trap.

In some embodiments, the container wall comprises a specialty metal alloy, stainless steel, glass, or ceramic.

In some further embodiments, a third acoustic sensor is coupled to the external surface of the container wall at a calculated distance (e.g., a required sensor separation distance) from at least the second acoustic sensor. In some further embodiments, each of the second acoustic sensor and the third acoustic sensor is configured to emit and receive acoustic waves, including bulk, interface, and/or guided waves, wherein, in operation, the system is configured to determined one or more physical properties of the process fluid in short-range.

According to another example embodiment, a non-invasive acoustic measuring method is provided, the method including coupling a first acoustic sensor and a second acoustic sensor to an external surface of a container wall, wherein the first acoustic sensor and the second acoustic sensor are configured to emit ultrasonic waves in different modalities; calculating a speed ratio (Vᵣ) of the first and second acoustic sensors; determining an average temperature (T_{avg}) of the container wall; calculating an average speed of the ultrasonic waves of at least one of the first acoustic sensor or the second acoustic sensor, wherein the average speed of the ultrasonic waves is based at least in part on the determined average temperature (T_{avg}) in the container wall; and determining a thickness of the container wall based at least in part on the calculated ultrasonic wave speed.

In some embodiments, the first acoustic sensor is a shear acoustic sensor and the second acoustic sensor is a longitudinal or compressive acoustic sensor. In some further embodiments, calculating the speed ratio (Vᵣ) of the first and second acoustic sensors comprises: measuring time of flight (TOF) for each of the shear acoustic sensor (TOFₛ) and the compressive acoustic sensor (TOF_{c}); and determining the speed ratio (Vᵣ) based on Equation (5):

$${V}_{r} = \frac{{V}_{c}}{{V}_{s}} = \frac{{V}_{avg , c}}{{V}_{avg , s}} = \frac{{TOF}_{s}}{{TOF}_{c}} \qquad Equation ( 5 )$$

In some embodiments, determining the average temperature (T_{avg}) of the container wall is based on a calculated linear relationship between the container wall temperature and the speed ratio.

In some embodiments, calculating the average speed of the ultrasonic waves of the shear acoustic sensor is based on Equation (10):

$${V}_{avg , s} = {m}_{s} {T}_{a v g} + {c}_{s} \qquad Equation ( 10 )$$

In some embodiments, calculating the average speed of the ultrasonic waves of the compressive acoustic sensor is based on Equation (9):

$${V}_{avg , c} = {m}_{c} {T}_{a v g} + {c}_{c} \qquad Equation ( 9 )$$

In some embodiments, the second acoustic sensor is proximate the first acoustic sensor.

In some embodiments, the method further includes determining a calculated distance (e.g., a required sensor separation distance) and coupling a third acoustic sensor to the external surface of the container wall, wherein the second and third acoustic sensors are separated by the required sensor separation distance. In some further embodiments, each of the second acoustic sensor and the third acoustic sensor is configured to emit and receive acoustic waves, including bulk, interface, and/or guided waves, wherein, in operation, the system is configured to determined one or more physical properties of the process fluid in short-range.

According to another example embodiment, a nondestructive method for characterization of short-range wall properties is provided, the method including coupling at least a first acoustic sensor and a second acoustic sensor to an external surface of a container wall; exciting a guided acoustic wave that is generated by the first acoustic sensor and received by the second acoustic sensor, wherein the guided acoustic wave interacts with a short-range wall section of the container wall as the guided acoustic wave travels between the two acoustic sensors; and determining property information about the short-range wall section based at least on the interactions of the guided acoustic wave with the short-range wall section of the container wall.

In some embodiments, the second acoustic sensor is proximate the first acoustic sensor.

In some further embodiments, a third acoustic sensor is coupled to the external surface of the container wall at a calculated distance (e.g., a required sensor separation distance) from at least the second acoustic sensor. In some further embodiments, each of the second acoustic sensor and the third acoustic sensor is configured to emit and receive acoustic waves, including bulk, interface, and/or guided waves, wherein, in operation, the system is configured to determined one or more physical properties of the process fluid in short-range.

According to another example embodiment, a nondestructive method for characterization of short-range wall-fluid interface properties is provided, the method including coupling a first acoustic sensor and a second acoustic sensor to an external surface of a container wall; exciting an interfacial acoustic wave that is generated by the first acoustic sensor and received by the second acoustic sensor, wherein the interfacial acoustic wave interacts with a short-range interfacial section of the container wall and a fluid contained by the container wall as the interfacial acoustic wave travels at a wall-fluid interface of the container wall between the two acoustic sensors; and determining property information about the short-range interfacial section based at least on the interactions of the interfacial acoustic wave with the short-range interfacial section.

In some embodiments, the second acoustic sensor is proximate the first acoustic sensor.

In some further embodiments, a third acoustic sensor is coupled to the external surface of the container wall at a calculated distance (e.g., a required sensor separation distance) from at least the second acoustic sensor. In some further embodiments, each of the second acoustic sensor and the third acoustic sensor is configured to emit and receive acoustic waves, including bulk, interface, and/or guided waves, wherein, in operation, the system is configured to determined one or more physical properties of the process fluid in short-range.

According to another example embodiment, a nondestructive method for characterization of short-range fluid properties is provided, the method included coupling a first acoustic sensor and a second acoustic sensor to an external surface of a container wall; exciting a fluid bulk acoustic wave that is generated by the first acoustic sensor and received by the second acoustic sensor, wherein the fluid bulk acoustic wave interacts with a short-range fluid region of a fluid contained by the container wall as the fluid bulk acoustic wave travels in a vicinity between the two acoustic sensors; and determining property information about the fluid in the vicinity between the two acoustic sensors based at least on the interactions of the fluid bulk acoustic wave with the short-range fluid region.

In some embodiments, the second acoustic sensor is proximate the first acoustic sensor.

In some further embodiments, a third acoustic sensor is coupled to the external surface of the container wall at a calculated distance (e.g., a required sensor separation distance) from at least the second acoustic sensor. In some further embodiments, each of the second acoustic sensor and the third acoustic sensor is configured to emit and receive acoustic waves, including bulk, interface, and/or guided waves, wherein, in operation, the system is configured to determined one or more physical properties of the process fluid in short-range.

Accordingly, improved aspects of the present disclosure include but are not limited to (1) temperature-compensated, accurate wall thickness measurements at high temperatures and high temperature gradients, (2) short range measurement of liquid, wall, and liquid-wall interface properties in large vessels or vessels with internal components, and (3) full physical characterization of fluids (non-invasive measurement of density, compressibility, and viscosity).

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject matter will become apparent from the description, the drawings, and the claims.

### BRIEF DESCRIPTION OF THE DRAWINGS

Having thus described certain example embodiments of the present disclosure in general terms above, non-limiting and non-exhaustive embodiments of the subject disclosure will now be described with reference to the accompanying drawings which are not necessarily drawn to scale. The components illustrated in the accompanying drawings may or may not be present in certain embodiments described herein. Some embodiments may include fewer (or more) components than those shown in the figures in accordance with an example embodiment of the present disclosure. Some embodiments may include the components arranged in a different way:

FIGS. 1A-1D schematically illustrate example acoustic measurement systems structured in accordance with various example embodiments of the present disclosure.

FIG. 2A depicts a top view of a stainless steel test plate with attached acoustic shear and compressive and thermocouples sensors in accordance with Example 1 of the present disclosure.

FIG. 2B depicts the stainless steel test plate of FIG. 2A along with the attached sensors placed in an oven for calibration in accordance with Example 1 of the present disclosure.

FIG. 3 schematically illustrates an experimental setup to perform pulse-echo measurement using shear (S) and compressive (C) acoustic sensors in accordance with Example 1 of the present disclosure.

FIG. 4A illustrates temperature measured at the top and bottom of the stainless steel test plate of FIG. 2A during calibration in accordance with Example 1 of the present disclosure.

FIG. 4B illustrates the calculated compressive and shear speed in the stainless steel test plate of FIG. 2A during calibration in accordance with Example 1 of the present disclosure.

FIG. 5A illustrates the acquired signal during pulse echo measurement with the compressive acoustic sensor attached to the stainless steel test plate of FIG. 2A in accordance with Example 1 of the present disclosure, with the first and fourth echo used for TOF calculation highlighted.

FIG. 5B illustrates the acquired signal during pulse echo measurement with the shear acoustic sensor attached to the stainless steel test plate of FIG. 2A in accordance with Example 1 of the present disclosure, with the first and fourth echo used for TOF calculation highlighted.

FIG. 6A illustrates the measured linear relationship between the temperature and the speed of shear and compressive modes in accordance with Example 1 of the present disclosure.

FIG. 6B illustrates the calculated linear relationship between the temperature and the speed ratio in accordance with Example 1 of the present disclosure.

FIG. 7 schematically illustrates the stainless steel test plate of FIG. 2A with arbitrary thermal profile T(x) in accordance with Example 1 of the present disclosure.

FIG. 8A schematically depicts a front cross-section view of the experimental setup of Example 1 of the present disclosure.

FIG. 8B schematically depicts a side cross-section view of the experimental setup of Example 1 of the present disclosure.

FIG. 9A illustrates the measured TOF for the compressive and shear sensors under continuous heating in accordance with Example 1 of the present disclosure.

FIG. 9B illustrates, in accordance with Example 1 of the present disclosure, the measured temperature using the thermocouple attached to the outer plate of the stainless steel test plate and the indirect temperature predicted via an example two-sensor method under continuous heating in accordance with various embodiments of the present disclosure.

FIG. 10A illustrates thickness measurement errors for “no compensation”, “1 Sensor+temp” and “2 sensor” methods under continuous heating in accordance with Example 1 of the present disclosure.

FIG. 10B illustrates the thickness measurement errors for “1 Sensor+temp” and “2 sensor” methods, separately compared for better visualization, under continuous heating in accordance with Example 1 of the present disclosure.

FIG. 11A illustrates the measured TOF for the compressive and shear sensors under intermittent heating in accordance with Example 1 of the present disclosure.

FIG. 11B illustrates, in accordance with Example 1 of the present disclosure, the measured temperature using the thermocouple attached to the outer plate of the stainless steel test plate and the indirect temperature predicted via an example two-sensor method under intermittent heating in accordance with various embodiments of the present disclosure.

FIG. 12A illustrates thickness measurement errors for “no compensation”, “1 Sensor+temp” and “2 sensor” methods under intermittent heating in accordance with Example 1 of the present disclosure.

FIG. 12B illustrates the thickness measurement errors for “1 Sensor+temp” and “2 sensor” methods, separately compared for better visualization, under intermittent heating in accordance with Example 1 of the present disclosure.

FIG. 13 illustrates a layered model representation of a steel container filled with liquid for dispersion curve generation in accordance with Example 2 of the present disclosure.

FIG. 14A illustrates calculated phase velocity versus frequency thickness for steel plate loaded with and without liquid along with attenuation of guided wave modes under 6 km/s in the presence of liquid in accordance with Example 2 of the present disclosure.

FIG. 14B illustrates calculated phase velocity versus frequency thickness for steel plate loaded with and without liquid along with attenuation of guided wave modes under 3 km/s in the presence of liquid in accordance with Example 2 of the present disclosure.

FIG. 15 illustrates normalized out-of-plane displacement of QS mode at the outer wall of the steel plate for different f.d values in accordance with Example 2 of the present disclosure.

FIG. 16 illustrates dispersion analysis of steel sample loaded with liquid that includes attenuation of all modes except QS and detectability of QS from the outer wall surface (obtained from wave structure analysis) in accordance with Example 2 of the present disclosure.

FIG. 17A illustrates a pressure field in the container cross-section at 45 μsec that illustrate the A0′, S0′, and QS modes along with the reflection from wall feature (WF) and internal component (IC) in accordance with Example 2 of the present disclosure.

FIG. 17B illustrates time domain plat of displacement recorded at the receiver probe, showing the arrival of primary guided waves and other reflections in accordance with Example 2 of the present disclosure.

FIG. 18 schematically illustrates an acquired signal with (red) and without (green) liquid illustrating the required temporal separation of QS and AG mode in accordance with Example 2 of the present disclosure.

FIG. 19A depicts a 5-gallon cylindrical steel pail with sensor holder and a transmitter-receiver sensor pair in accordance with Example 2 of the present disclosure.

FIG. 19B depicts a 22-gallon cuboid shaped steel container with sensor holder and a transmitter-receiver sensor pair in accordance with Example 2 of the present disclosure.

FIG. 20A depicts an experimental setup showing a data acquisition system that contains a laptop PC, a pre-amplifier, and an oscilloscope with an arbitrary wave form generator (AWG) in accordance with Example 2 of the present disclosure.

FIG. 20B depicts an experimental setup showing a sensor assembly with 3D printed adjustable sensor holder and a transmitter-receiver sensor pair in accordance with Example 2 of the present disclosure.

FIGS. 21A-21D depict acquired voltage by receiver with and without the presence of liquid at different f.d values for the cylindrical steel pail in accordance with Example 2 of the present disclosure.

FIGS. 22A-22D depict acquired voltage by receiver with and without the presence of liquid at different f.d values for the cuboid shaped steel container in accordance with Example 2 of the present disclosure.

FIG. 23 depicts the liquid detection parameter D calculated for each acquired signal during the experiment conducted with the cylindrical steel pail and the cuboid shaped container in accordance with Example 2 of the present disclosure.

FIG. 24 schematically depicts an example application of a short-range method in accordance with various embodiments of the present disclosure on a cylindrical container with a wall feature in accordance with Example 3 of the present disclosure.

FIG. 25 depicts a flowchart broadly illustrating a series of to perform nondestructive characterization steps in accordance with example embodiments of the present disclosure.

FIG. 26 depicts a flowchart broadly illustrating a series of steps to non-invasively determine a thickness of a container wall in accordance with example embodiments of the present disclosure.

FIG. 27 depicts a flowchart broadly illustrating a series of steps to perform non-invasive short-range measurement of wall properties in a container wall in accordance with example embodiments of the present disclosure.

FIG. 28 depicts a flowchart broadly illustrating a series of steps to perform non-invasive short-range measurement of wall-fluid interface properties in a container in accordance with example embodiments of the present disclosure.

FIG. 29 depicts a flowchart broadly illustrating a series of steps to perform non-invasive short-range measurement of fluid properties in a container in accordance with example embodiments of the present disclosure.

FIG. 30 depicts estimation of fluid physical properties such as viscosity, bulk modulus, and density of a process fluid in accordance with example embodiments of the present disclosure.

### DETAILED DESCRIPTION

Various example embodiments of the present disclosure are more fully described hereafter with reference to the accompanying drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details. It should be understood that some, but not all, embodiments of the present disclosure are shown and described herein. Indeed, embodiments of the present disclosure may be embodied in many different forms, and accordingly this disclosure should not be construed as limited to the embodiments set forth herein; rather, these embodiments are provided so that this disclosure will satisfy applicable legal requirements.

### Overview

The inventors have determined that it would be desirable and advantageous to have the ability to, in real-time and in a non-invasive manner, measure container wall corrosion, wall-fluid interface characteristics (e.g., indicative of corrosion products or deposits), and process fluid physical properties (e.g., density, bulk modulus, and viscosity) in nuclear energy and other complex environments to identify leakages or any other damages in pipes, container, vessels, containment structures, and/or fluids in nuclear systems. For example, such tools and techniques may assist in testing and assessment of containers (e.g., monitoring etch rate, detecting corrosion or wall loss in vessels, pipelines, etc.) and the fluid-contents of such containers in nuclear energy research, fuel production processes, and reactor demonstration systems.

Conventional invasive or mechanical approaches require direct contact with the liquid medium or otherwise require permanent alteration of the container to accommodate mechanical systems or sensors. The implementation of common non-invasive, non-destructive evaluation (NDE) tools in nuclear research and applications, however, is challenging due to potentially harsh or hazardous environments involving high temperatures and/or high radiation levels. The inventors have also determined that it would be desirable and advantageous to have both highly accurate and highly sensitive measurements because of the low risk tolerance for mechanical failure and accidental material leakage in nuclear energy systems.

Among various NDE methods, the inventors have determined that acoustic NDE is particularly attractive in nuclear energy due to its non-invasive deployment, low cost, portability, speed, and sensitivity. Yet, current acoustic container-wall and liquid-content characterization techniques are established mostly for stable room temperature operation, on simple vessel geometries, and in non-radiation environments. Conventional acoustic approaches are typically limited to operation at room or low temperatures (<80° C.) and are optimized to measure one physical property, such as wall thickness of a container or process liquid density in a pipe. At high temperatures (>80° C.), the effects of temperature on acoustic wave propagation become significant, necessitating the use of temperature compensation methods. But such compensation methods cannot be easily generalized if the temperature profile in the system is not readily available. For example, a temperature gradient uncertainty of order 10° C./mm in steel increases relative wall thickness measurement error from (e.g., best case) ±0.1 to approximately ±0.8 micron/mm. Similar uncertainty arguments apply to other measured properties.

Measuring the thermal profile precisely in real time is extremely difficult due to the lack of access to the inner wall, as well as the lack of information on all the contributing heat sources and sinks influencing the thermal profiles within the thickness. Traditional methods of such temperature compensation typically rely on externally measuring a temperature of a wall of a vessel, assuming that the whole wall thickness is at that same measured (or at room temperature) temperature (i.e., in an isothermal condition), and then calculating a thickness of such wall based on such assumed temperature compensation. However, the inventors have determined that, in reality, the wall of a vessel (or pipe or container or other containment structure) is not at a uniform temperature. In most instances, such walls will have a non-uniform distribution of temperature and existing techniques cannot address such issues, leading to operations interruption and production loss in order to bring the test structure under inspection into an isothermal condition and large errors in the thickness measurement, especially in instances of appreciable thermal gradients, fluctuating temperatures, significant temperature variations across the thickness, complex heat distribution, complex heating/cooling mechanisms (e.g., not just assuming the heating source is only from the inner wall), or otherwise large and rapidly varying thermal gradients with time.

To overcome these problems and others, various embodiments of the present disclosure are directed to a novel temperature compensation method that acoustically determines container wall thickness measurements with high accuracy and precision at high temperatures and high temperature gradients or otherwise under virtually any arbitrary thermal profile within the thickness. In some embodiments, real-time temperature compensation is enabled for such thickness measurement, the real-time aspect allowing for rapid temperature compensation even when under rapidly changing thermal conditions and corresponding highly time-variant temperature profiles exist in the inspected structure. For example, in some embodiments, two or more sensors are attached to the exterior wall of the vessel and at least two of the two or more sensors comprise different operating modalities, such as a first sensor comprising a shear acoustic sensor and a second sensor comprising a longitudinal or compressive acoustic sensor. In various embodiments described herein, such sensors may operate with a non-iterative rapid signal processing technique to instantaneously determine the actual thickness of the wall, while compensating for the temperature automatically. Such embodiments of the present disclosure can be utilized in any gradient of temperature without the requirement for temperature assumptions to provide a more accurate wall thickness measurement. Indeed, example embodiments of the present disclosure using such compressive and shear excitations show an error in thickness estimation can be reduced by up to 98% compared to conventional thickness gauging methods with no temperature compensation, and by approximately 75% compared to techniques that measure outer wall temperature and assume a uniform temperature profile. Accordingly, various embodiments of the present disclosure advantageously compensate for temporal and spatial variations in temperature in the inspected structure in real time and demonstrate a high tolerance for rapidly changing sub-surface thermal profiles.

Conventional acoustic measurements typically rely on precise timing of long-range time of flight (TOF) measurements requiring two diametrically opposed sensors or otherwise deploying a sensor on one end of a vessel, sending acoustic waves through the entirety of the vessel to hit the inner wall on other side of vessel, and then the return signal bouncing back and being received at the same sensor or same location. However, large vessels, internal components, and/or complex or irregular geometry of the vessel or the internal components may result in multiple signal reflections, which restricts use of such existing long-range techniques for characterization of fluid contents. To overcome these problems and others, various embodiments of the present disclosure advantageously provide short range measurement of liquid properties, which the inventors have determined would be desirable and advantageous for use in large containers or vessels, complex vessels, or otherwise in containers with internal component(s). In some embodiments of the present disclosure, for example, using the wall thickness as acoustically identified by the at least two sensors of the two or more sensors as discussed herein, the second sensor (e.g., the longitudinal acoustic sensor) may be configured to send an interface wave along the interface of the inner wall of the vessel and the interior volume of the vessel with a third sensor (e.g., another longitudinal acoustic sensor) configured to detect or otherwise receive the interface wave within a short range. For example, the second sensor and the third sensor may be disposed a short range (e.g., “ds”) from one another on the exterior wall of the vessel. That is, various embodiments of the present disclosure perform acoustic measurements by advantageously carrying out such measurements in short range with closely spaced sensors, such that the techniques can be implemented in a small part of a big structure, independent of the overall vessel shape or whether there are any internal components and does not require full access to the vessel or otherwise placing sensors in other locations in the vessel (e.g., diametrically opposed) for short range measurement of liquid properties of the fluid contents.

The inventors have also determined that the short range acoustic waves discussed herein penetrate through fluid if there is fluid present inside the containment structure, and by observing how such short wave acoustic waves interact with the fluid, various embodiments of the present disclosure enable a full physical characterization of such fluid, including the non-invasive measurement of three important physical parameters, including density, bulk modulus (e.g., compressibility), and viscosity. For example, in some embodiments, density and bulk modulus of a process fluid may be calculated using impedance and wave speed information, while the effective viscosity of the process fluid may be determined using absorption information together with impedance and wave speed information. Such physical parameters of the fluid may be important for different aspects of a flow system, such as a cooling loop in a nuclear reactor. Indeed, in many applications, including nuclear applications, the flow characteristics and the physical characteristics of the fluid may be important for the safe operation of the system. For example, if there are lots of changes in the composition of the fluid flowing through the system, it is important to know about such composition changes and as soon as possible, which can be achieved by the density monitoring enabled in various embodiments of the present disclosure. Bulk modulus (compressibility) of the fluid and viscosity of the fluid, which are determined by various embodiments of the present disclosure, are also important for safe operation of a flow loop, where cooling needs to happen at a certain rate with a certain pumping power. Such embodiments of the present disclosure can be utilized to enable the short range measurement of such important fluid characteristics—density, bulk modulus (e.g., compressibility), and viscosity.

Various embodiments of the present disclosure use standard, off-the-shelf commercial acoustic sensors, which can typically go up to about 500° C. Additionally or alternatively still, in some embodiments, a standoff may be utilized between any sensor and the container wall instead of attaching the sensor itself directly on the wall, allowing the sensor to be removed from the heat source but still allow the acoustic waves to go in and out. Additionally or alternatively further still, one or more sensors that can withstand very high temperatures may be utilized in example embodiments of the present disclosure. For example, an acoustic sensor of one or more embodiments of the present disclosure may comprise piezoelectric crystals that can operate at temperatures upwards of 800° C., allowing the acoustic sensor to be used directly on a (hot) wall of the vessel. In certain embodiments, a standoff may be placed between such a piezoelectric crystal sensor and the container wall.

Depending on the radiation levels of the system to be sensed or surrounding components, materials may degrade, such as the sensor itself, the electrodes, the housing, etc. In various embodiments of the present disclosure, one or more sensors comprise one or more sensor components encapsulated within a radiation shield housing or radiation shielding (e.g., lead, nickel-alloy, etc.). In some embodiments, an entire sensor is encapsulated within a radiation shield housing or radiation shielding. The inventors have also determined that a standoff may additionally or alternatively be placed between a sensor and the wall to reduce radiation exposure to the sensor. That is, standoffs provide additional flexibility to keep the sensors at a distance from high temperatures and high radiation environments, thus allowing usage of wider selection of sensors with reduced temperature and radiation tolerance requirements.

Example embodiments of the present disclosure address the various deficiencies set forth above and described herein and otherwise fill technology gaps in non-invasive process diagnostics and structural health monitoring of emerging fuel fabrication and advanced nuclear reactor demonstration systems. For example, in some embodiments, a temperature compensation method that acoustically determines temperature profiles is combined with a multi-property measurement technique, enabling real-time, non-invasive measurement of container wall corrosion, wall-fluid interface characteristics (e.g., indicative of corrosion products or deposits), and process fluid physical properties (e.g., density, bulk modulus, and viscosity). In one example embodiment, high-temperature sensors that are protected in radiation-shielding Ni-alloy sheaths, result in a capability for comprehensive physical characterization of pipes and vessels, and their fluid contents in a wide range of temperatures (e.g., up to 570° C. demonstrated using commercially available and certified sensors and up to 800° C. with a piezoelectric crystal sensor) and radiation levels (e.g., up to integrated gamma dose of 109 rad and integrated neutron dose of 2×1017 n/cm² demonstrated using commercially available and certified sensors), which is not possible with existing commercial techniques. In another example embodiment, one or more standoffs are disposed between the surface of the wall to be interrogated and at least one of the sensors. By performing acoustic measurements with closely spaced sensors, the techniques described herein can be implemented in a small part of a big structure, independent of the overall vessel shape or whether there are any internal components.

These characteristics as well as additional features, functions, and details are described below. Similarly, corresponding and additional embodiments are also described below. The various implementations of the acoustic-based characterization techniques of the present disclosure are not limited to nuclear energy research and industrial applications and can instead be configured for use with other technologies that might be of interest to a user. That is, one of ordinary skill in the art will appreciate that the non-destructive, acoustic-based characterization related concepts discussed herein may be applied to a wide variety of other technologies wherein highly accurate and highly sensitive measurements are needed in potentially harsh or hazardous environments involving high temperatures and/or high radiation levels, such as, but not limited to, chemical and petrochemical process industries, fusion reactor systems, power plants, and aerospace engine monitoring structures, as well as in other environments such as civil infrastructure (e.g., bridges, pipelines, and other infrastructure components), healthcare ultrasound imaging, and the automotive industry.

### Exemplary Embodiments of the Present Disclosure

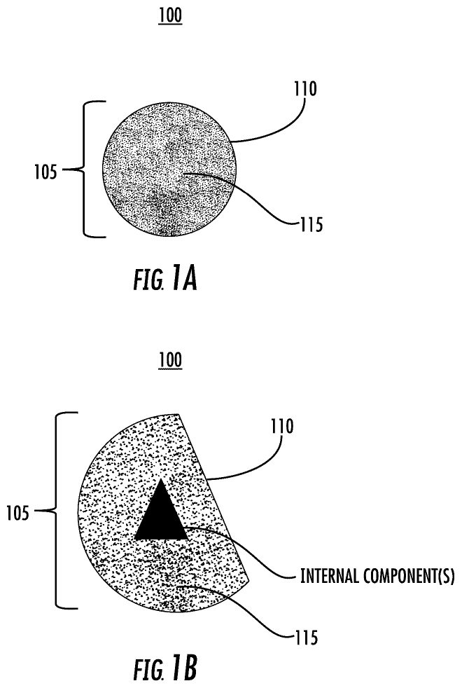

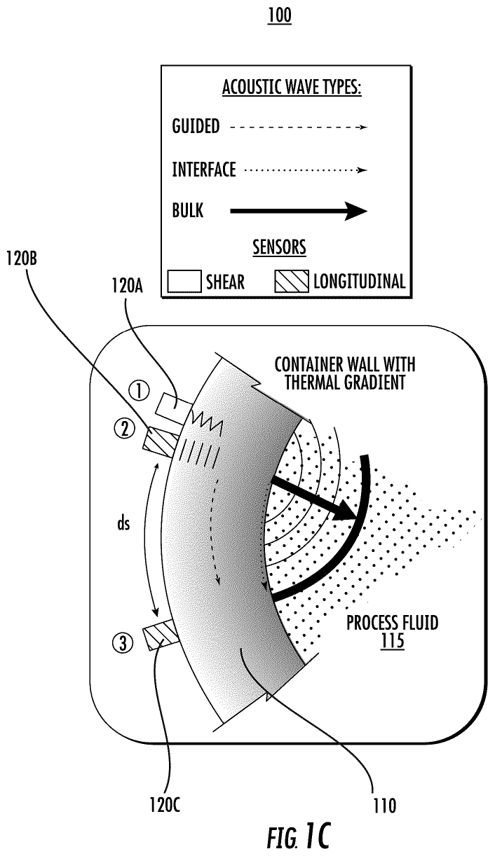

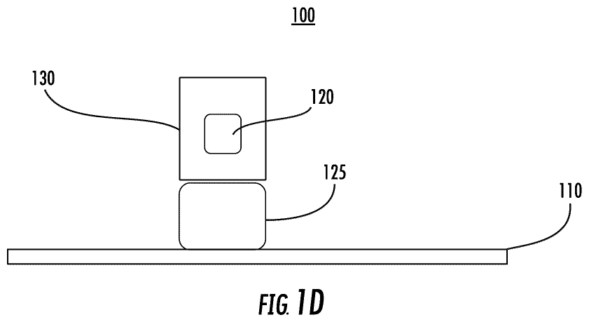

FIGS. 1A-1C schematically illustrate an example acoustic measurement system 100 structured in accordance with various example embodiments of the present disclosure. As depicted in FIGS. 1A and 1B, the acoustic measurement system 100 may comprise an example container 105. The container 105 may be a pipe, vessel, or any other containment structure to be inspected. In a non-limiting example, the container 105 may be a container in a nuclear pilot plant or industrial plant, such as a flow pipe with a circular cross-section as depicted in FIG. 1A or a large tank or vessel of irregular shape with internal components of irregular shape as depicted in FIG. 1B. Internal components include, but are not limited to, mixing elements, wave breakers, splash plates, sand traps, etc. The present disclosure contemplates that the container 105 may be of any suitable structure, size, and/or shape as needed for its intended application. For example, the container 105 may have a square, elongated, or rectangular cross-section or may be of irregular shape.

With continued reference to FIGS. 1A and 1B, the container 105 comprises a container wall 110 structurally defining an internal cavity of the container 105, with a process fluid 115 disposed within such internal cavity. The present disclosure contemplates that the container wall 110 may be formed any suitable material(s) as needed for its intended application. For example, in a non-limiting example, the container wall 110 is formed of stainless steel, but any solid-wall material may be used, including specialty metal alloys, ceramics, or glass.

FIG. 1C depicts a close-up schematic illustration of a portion of the example container wall 110 of the container 105 of FIG. 1A and the container 105 of FIG. 1B. As depicted, the container wall 110 has a thermal gradient.

An acoustic sensor 120 is an acoustic excitation device that can emit sound waves according to one or more acoustic frequencies. For example, in some embodiments, an example acoustic sensor 120 emits waves according to an ultrasonic frequency. In some embodiments, the acoustic measurement system 100 comprises two or more acoustic sensors 120. For example, with reference to FIG. 1C, two or more acoustic sensors 120 may be attached to an external surface of the container wall 110 of the container 105. In some embodiments, the second acoustic sensor is proximate or otherwise placed close to the first acoustic sensor.

The present disclosure contemplates that the acoustic sensors 120 may be coupled or attached to the external surface of the container wall 110 by any suitable method as needed for its intended application. For example, the acoustic sensors 120 may be permanently attached, such as via super glue or other attachment method, or removably attached. In some examples, one or more of the acoustic sensors 120 may be coupled, mounted, or attached using clamps, clamping systems, straps, wax, adhesives, and/or the like.

In some embodiments, an acoustic sensor 120 comprises a standard, off-the-shelf commercial acoustic sensor, which can typically go up to about 500° C. In other embodiments, an acoustic sensor 120 may comprise piezoelectric crystals that can operate at temperatures upwards of 800° C., allowing the acoustic sensor 120 to be used directly on a (hot) container wall 110 of the container 105.

In some embodiments, an acoustic sensor 120 may be configured to emit waves according to a different modality than another acoustic sensor 120 of the acoustic measurement system 100. In some embodiments, a first acoustic sensor 120A emits waves according to a first modality and a second acoustic sensor 120B emits waves according to a second, different modality. For example, with reference to FIG. 1C, in some embodiments, a first acoustic sensor 120A is a shear acoustic sensor configured to emit or propagate waves in shear mode and a second acoustic sensor 120B is a longitudinal or compressive acoustic sensor configured to emit or propagate waves in longitudinal or compressive mode. In some further embodiments, a third acoustic sensor 120C is coupled to the external surface of the container wall 110. In certain embodiments, the third acoustic sensor 120C emits waves according to the second modality. For example, with reference to FIG. 1C, in some embodiments, both the second acoustic sensor 120B and third acoustic sensor 120C are longitudinal or compressive acoustic sensors configured to emit or propagate waves in longitudinal or compressive mode.

As depicted in FIG. 1C, the second acoustic sensor 120B and the third acoustic sensor 120C may be disposed a distance “ds” (a sensor separation distance) or a required sensor separation distance from each other on the external surface of the container wall 110. The distance “ds” enables the second acoustic sensor 120B and the third acoustic sensor 120C to operate within short range. For example, in some embodiments, the second acoustic sensor 120B may be configured to emit or propagate an interface wave along the inner surface of the container wall 110 of the container 105, such inner surface forming the interface of the container 105 and the process fluid 115 disposed within the interior cavity of the container 105. With continued reference to such example embodiment, the third acoustic sensor 120C may be configured to detect or otherwise receive the interface wave within a short range.

In some embodiments, each of the second acoustic sensor and the third acoustic sensor is configured to emit and receive acoustic waves, including bulk, interface, and/or guided waves. In some embodiments, such arrangement enables determination of one or more physical properties of the process fluid in short-range.

FIG. 1C illustrates the short-range wave propagation in the close vicinity of the container wall 110 of the container 105 of FIG. 1A or 1B. When stress waves are excited in the outer wall 110 of the container 105 (e.g., such as emitted by acoustic sensor 120B), a multi-modal primary guided wave travels along the container wall 110. The guided wave also couples varying levels of energy into the liquid medium (process fluid 115) as it travels depending on the propagation mode. In addition to the guided wave, a non-dispersing bulk wave travels within the liquid medium (process fluid 115) as depicted in FIG. 1C.

FIG. 1D illustrates an example standoff 125 positioned between a sensor 120 and a container wall 110. In some embodiments, a standoff 125 is optionally positioned between any one or more sensors 120 and the container wall 110. For example, a standoff 125 may be utilized between any sensor 120 and the container wall 110 instead of attaching the sensor 120 itself directly on the container wall 110, allowing the sensor 120 to be removed from the heat source but still allow the acoustic waves to go in and out. A standoff 125 may additionally or alternatively be placed between a sensor 120 and the container wall 110 to reduce radiation exposure to the sensor 120. That is, standoffs 125 may provide additional flexibility to keep the sensors 120 at a distance from high temperatures and high radiation environments, thus allowing usage of wider selection of sensors 120 with reduced temperature and radiation tolerance requirements.

FIG. 1D illustrates optional radiation shield housing or radiation shielding 130 encapsulating a sensor 120. Depending on the radiation levels of the system 100 to be sensed or surrounding components, materials may degrade, such as the sensor 120 itself, the electrodes, the housing, etc. In various embodiments of the present disclosure, one or more sensors 120 comprise one or more sensor components encapsulated within a radiation shield housing or radiation shielding 130 (e.g., lead, nickel-alloy, etc.). In some embodiments, an entire sensor 120 is encapsulated within a radiation shield housing or radiation shielding 130.

### Example Methods

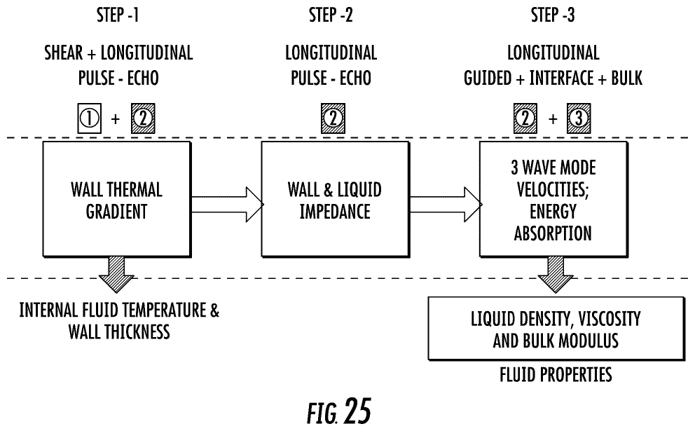

Having described the exemplary acoustic measurement system of the present disclosure, it should be understood that nondestructive acoustic-based characterization of container wall corrosion, wall-fluid interface characteristics, and process fluid physical properties (e.g., density, bulk modulus, and viscosity) in such an acoustic measurement system may be performed in a number of ways. FIGS. 25-29 are flowcharts broadly illustrating a series of steps to perform such nondestructive characterization, for example, of the acoustic measurement system 100 as described above.

FIG. 25 depicts a flowchart broadly illustrating a series of to perform nondestructive characterization steps according to the present disclosure including (1) temperature-compensated, accurate wall thickness measurements at high temperatures and high temperature gradients (e.g., using the first acoustic sensor 120A and the second acoustic sensor 120B), (2) wall and liquid impedance (e.g., using the second acoustic sensor 120B), (3) short range measurement of liquid, wall, and liquid-wall interface properties in large vessels or vessels with internal components (e.g., using the second acoustic sensor 120B and the third acoustic sensor 120C), and (4) full physical characterization of fluids (non-invasive measurement of density, compressibility, and viscosity).

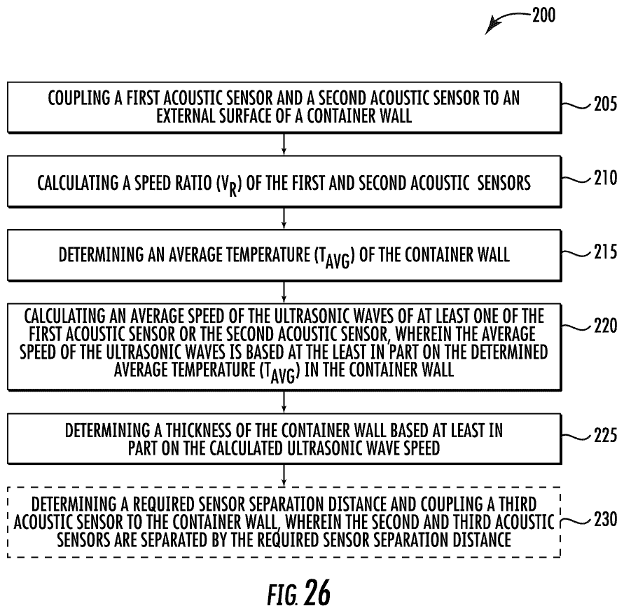

Turning to FIG. 26, a temperature-compensated, nondestructive method 200 for determining the thickness (h) of a container wall is provided. As shown in FIG. 26, step 205 comprises coupling a first acoustic sensor and a second acoustic sensor to an external surface of a container wall, wherein the first acoustic sensor and the second acoustic sensor are configured to emit ultrasonic waves in different modalities. For example, in some embodiments, the first acoustic sensor is a shear acoustic sensor and the second acoustic sensor is a longitudinal or compressive acoustic sensor.

As shown in FIG. 26, step 210 comprises calculating a speed ratio (Vᵣ) of the first and second acoustic sensors. For example, in some embodiments, the speed ratio is calculated based on using the measured time of flight (TOF) from the first acoustic shear sensor (TOFₛ) and the second compressive acoustic sensor (TOF_{c}) in accordance with Equation (5):

$${V}_{r} = \frac{{V}_{c}}{{V}_{s}} = \frac{{V}_{avg , s}}{{V}_{avg , s}} = \frac{{TOF}_{s}}{{TOF}_{c}} \qquad Equation ( 5 )$$

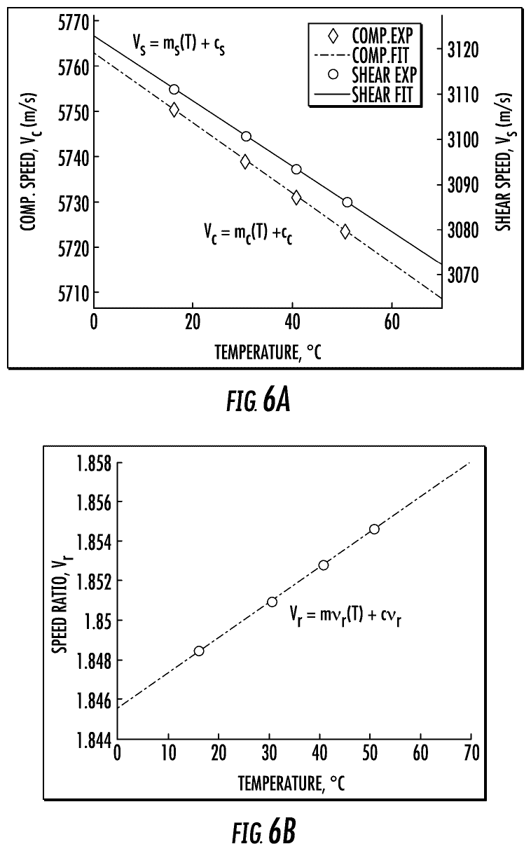

With continued reference to FIG. 26, step 215 comprises determining an average temperature (T_{avg}) of the container wall. For example, in some embodiments, the average temperature of the container wall is determined using a calculated linear relationship between the container wall temperature and the speed ratio, for example, as depicted in FIG. 6B.

As shown in FIG. 26, step 220 comprises calculating an average speed of the ultrasonic waves of at least one of the first acoustic sensor or the second acoustic sensor, wherein the average speed of the ultrasonic waves is based at least in part on the determined average temperature (T_{avg}) in the container wall. For example, in some embodiments wherein the first acoustic sensor is a shear acoustic sensor, the average speed of the ultrasonic waves of the first shear acoustic sensor (shear mode) is calculated in accordance with Equation (10):

$${V}_{avg , s} = {m}_{s} {T}_{a v g} + {c}_{s} \qquad Equation ( 10 )$$

In some embodiments wherein the second acoustic sensor is a compressive acoustic sensor, the average speed of the ultrasonic waves of the second compressive acoustic sensor (compressive mode) is calculated in accordance with Equation (10):

$${V}_{avg , c} = {m}_{c} {T}_{a v g} + {c}_{c} \qquad Equation ( 9 )$$

As shown in FIG. 26, step 225 comprises determining a thickness of the container wall based at least in part on the calculated ultrasonic wave speed. For example, in some embodiments, the thickness (h) of the container wall may be determined by calculating h in either of the following equations:

$${V}_{avg , c} = \frac{2 \times h}{{TOF}_{c}} \qquad Equation ( 3 )$$

$${V}_{avg , s} = \frac{2 \times h}{{TOF}_{s}} \qquad Equation ( 4 )$$

As shown in FIG. 26, step 230 may optionally comprise determining a required sensor separation distance and coupling a third acoustic sensor to the container wall, wherein the second and third acoustic sensors are separated by the required sensor separation distance.

In some embodiments, the second acoustic sensor 120B is independently used to measure acoustic impedance and energy absorption in the process fluid, using pulse echo.

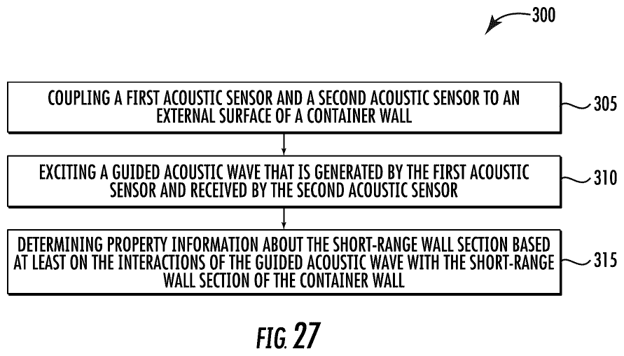

As previously depicted in Step 3 of FIG. 25, in some embodiments, the second and third acoustic sensors may be used as a short-range sensor pair to identify acoustic wave velocity in the container wall, liquid medium, and wall-fluid interface. For example, turning to FIG. 27, a nondestructive method 300 for characterization of short-range wall properties is provided. As shown in FIG. 27, step 305 includes coupling at least a first acoustic sensor and a second acoustic sensor to an external surface of a container wall. In some embodiments, the nondestructive method 300 may optionally include three acoustic sensors, wherein two acoustic sensors are arranged to perform the method 200 of FIG. 26 to determine a thickness of the container wall and a third acoustic sensor is arranged at a distance ds from at least one of the two acoustic sensors (e.g., the original second acoustic sensor), the second and third acoustic sensors arranged as a short-range pair to identify acoustic wave velocity in the container wall and the liquid medium (e.g., process fluid 115) contained within the container.

As shown in FIG. 27, step 310 includes exciting a guided acoustic wave that is generated by the first acoustic sensor (e.g., 120B) and received by the second acoustic sensor (e.g., 120C), wherein the guided acoustic wave interacts with a short-range wall section of the container wall (e.g., 110) as the guided acoustic wave travels between the two acoustic sensors.

Turning to step 315, the method 300 includes determining property information about the short-range wall section based at least on the interactions of the guided acoustic wave with the short-range wall section of the container wall.

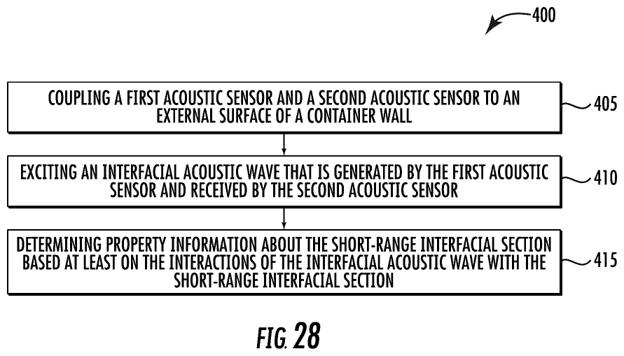

Turning to FIG. 28, a nondestructive method 400 for characterization of short-range wall-fluid interface properties is provided. As shown in FIG. 28, step 405 includes coupling a first acoustic sensor and a second acoustic sensor to an external surface of a container wall. Similar to FIG. 27, in some embodiments, the nondestructive method 400 may optionally include three acoustic sensors, wherein two acoustic sensors are arranged to perform the method 200 of FIG. 25 to determine a thickness of the container wall and a third acoustic sensor is arranged at a distance ds from at least one of the two acoustic sensors (e.g., the original second acoustic sensor), the second and third acoustic sensors arranged as a short-range pair to identify acoustic wave velocity in the container wall and the liquid medium (e.g., process fluid 115) contained within the container.

As shown in FIG. 28, step 410 includes exciting an interfacial acoustic wave that is generated by the first acoustic sensor and received by the second acoustic sensor, wherein the interfacial acoustic wave interacts with a short-range interfacial section of the container wall and a fluid contained by the container wall as the interfacial acoustic wave travels at a wall-fluid interface of the container wall between the two acoustic sensors.

Turning to step 415, method 400 further includes determining property information about the short-range interfacial section based at least on the interactions of the interfacial acoustic wave with the short-range interfacial section.

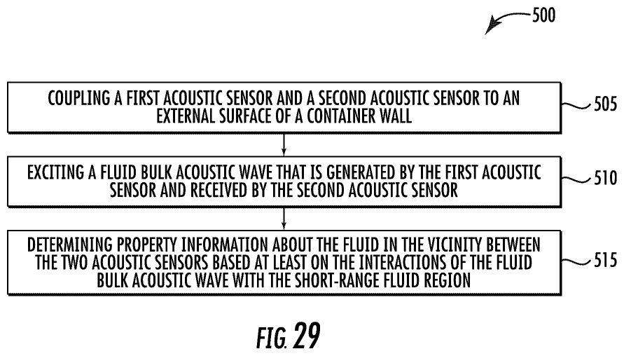

Turning to FIG. 29, a nondestructive method 500 for characterization of short-range process fluid properties is provided. As shown in FIG. 29, step 505 includes coupling a first acoustic sensor and a second acoustic sensor to an external surface of a container wall. Similar to FIGS. 27 and 28, in some embodiments, the nondestructive method 500 may optionally include three acoustic sensors, wherein two acoustic sensors are arranged to perform the method 200 of FIG. 26 to determine a thickness of the container wall and a third acoustic sensor is arranged at a distance ds from at least one of the two acoustic sensors (e.g., the original second acoustic sensor), the second and third acoustic sensors arranged as a short-range pair to identify acoustic wave velocity in the container wall and the liquid medium (e.g., process fluid 115) contained within the container.

As shown in FIG. 29, step 510 includes exciting a fluid bulk acoustic wave that is generated by the first acoustic sensor and received by the second acoustic sensor, wherein the fluid bulk acoustic wave interacts with a short-range fluid region of a fluid contained by the container wall as the fluid bulk acoustic wave travels in a vicinity between the two acoustic sensors.

Turning to step 515, method 500 further includes determining property information about the fluid in the vicinity between the two acoustic sensors based at least on the interactions of the fluid bulk acoustic wave with the short-range fluid region.

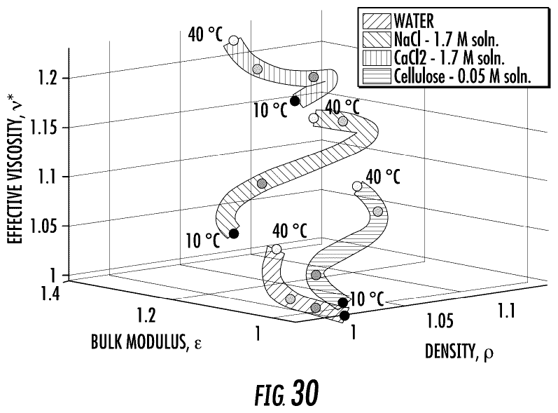

In some embodiments, the determined impedance values (e.g., as determined in methods 300, 400, and/or 500) are combined with the wave speed and energy absorption values, to determine (e.g., estimate) fluid physical properties such as the density, bulk modulus (or, compressibility), and viscosity as depicted in FIG. 30. In FIG. 30, density and bulk modulus within the test structure were calculated by using impedance and wave speed information, while the effective viscosity within the same test structure was determined using absorption information together with impedance and wave speed information.

### EXAMPLES

The following preparations and examples are provided to enable those skilled in the art to more clearly understand and practice the presently described subject matter. The Examples should not be considered as limiting in scope of the subject matter described herein, but merely as being illustrative and representative.

### Example 1: Measuring Plate Thickness

### Calibration

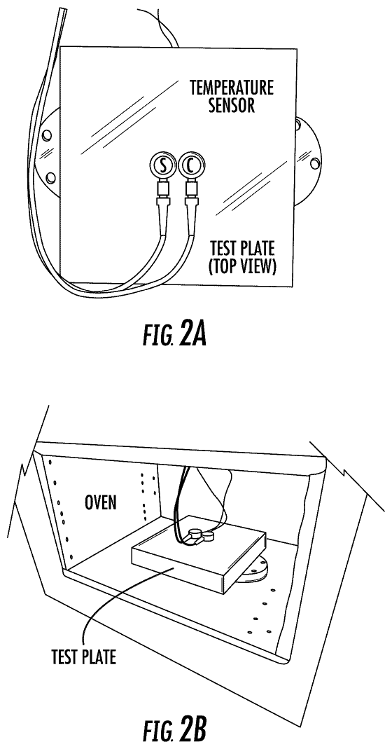

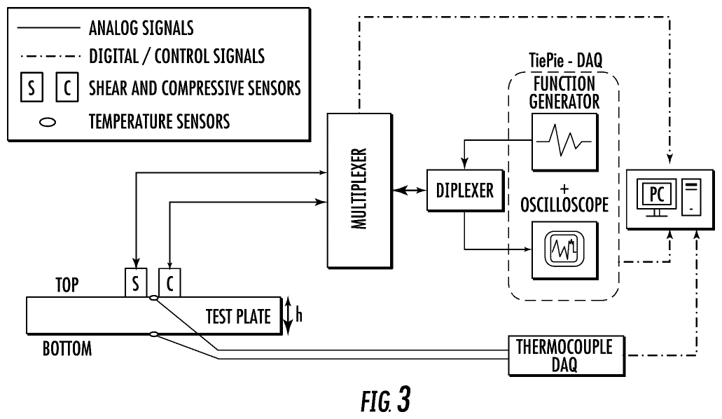

To identify the relationship between the temperature and the speed of shear and compressive ultrasonic wave, a 304 stainless steel plate with a dimension of 15.24×15.24 cm and a thickness of 2.54 cm, as shown in FIG. 2A, is provided. A compressive acoustic sensor (C) (Model No. V109; Evident Scientific, Inc.; Waltham, MA, USA) and a shear acoustic sensor (S) (Model No. V153; Evident Scientific, Inc.; Waltham, MA, USA) with central resonant frequency of 5 MHz are attached to a top of the plate using super glue, as depicted in FIG. 2A. Both sensors are operated under pulse-echo mode in a sequential manner to avoid interference. K-type thermocouple temperature sensors (Olympus Inc.; Waltham, MA, USA) are attached to the top and bottom of the plate, as shown in FIG. 3.

The experimental setup consists of four major components:

(1) a Tie-Pie (model: HS5-540XMS-W5; Koperslagersstraat, Sneek; The Netherlands) data acquisition (DAQ) unit, equipped with an arbitrary waveform generator (AWG) and an oscilloscope, is used for the generation and acquisition of analog acoustic signals. A diplexer (model: RDX-6; RITEC, Inc.; Warwick, RI, USA), connected to the DAQ, is used to isolate the echo signal during pulse-echo operation.

(2) A multiplexer (model: 34980A; Keysight; Santa Rosa, CA, USA) is used to switch the operation between compressive and shear sensors.

(3) A Thermocouple DAQ is used to convert the analog thermocouples sensor data to digital data.

(4) A personal computer (PC) with Python interface is used to control the DAQs, multiplexer, and save the data.

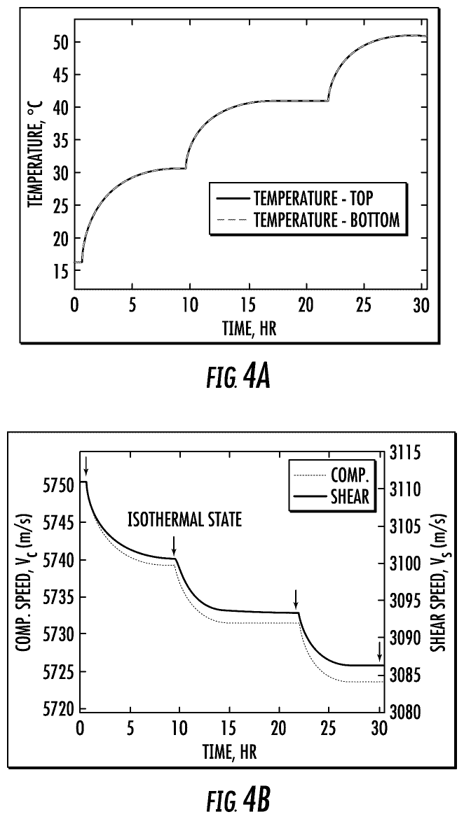

During calibration, the test plate is placed in an oven, as shown in FIG. 2B. The temperature of the oven is increased from room temperature (18° C.) to 30, 40, and 50° C., with at least 8 hours between each increase to achieve steady state for high precision measurements. Temperature measured by the thermocouples attached to the bottom and top of the plate are shown in FIG. 4A. It can be observed that the plate surfaces reach steady state temperatures at 8 hours, however, this does not ensure an isothermal condition through the plate thickness. Ultrasonic waves propagating through the thickness of the plate can be used to sensitively determine any sub-surface thermal gradients. As an additional check on the steady state condition, propagation speed of shear and compressive waves are tracked until they reach steady state, as shown in FIG. 4B. For calibration purposes, it is assumed that an isothermal condition has been achieved when the temperature and speed measurements reach steady state and the difference between the top and bottom temperature reading approaches zero.

A Gaussian pulse with a center frequency of 5 MHz with 0.5 bandwidth (fractional bandwidth in the frequency domain of pulse) is used for the pulse-echo measurements. Gaussian pulse generated by the AWG is used to excite the acoustic sensor via the diplexer and the multiplexer. The multiplexer helps to switch the operation between shear and compressive modes electronically. The diplexer is used to isolate the echo signal during the pulse-echo operation, as shown in FIG. 3.

Acquired signals are sampled at 200 mega samples per second by the digitizing oscilloscope. Signals from the thermocouples attached to the top and bottom of the test plate are digitized using the thermocouples DAQ (model: USB-TC; Digilent; Pullman, WA, USA). The PC (with Python software, version 3.11.7) is used to control all the equipment and store the data.

The temperature measurement of the plate and the pulse echo measurement using compressive and shear sensors are conducted in rapid succession in less than 8 seconds, allowing for near real-time capture of transient effects when non-steady-state temperature effects are studied. All the measured temperature and acoustic signals are stored in the PC. This procedure is repeated every 5 minutes during the calibration process.

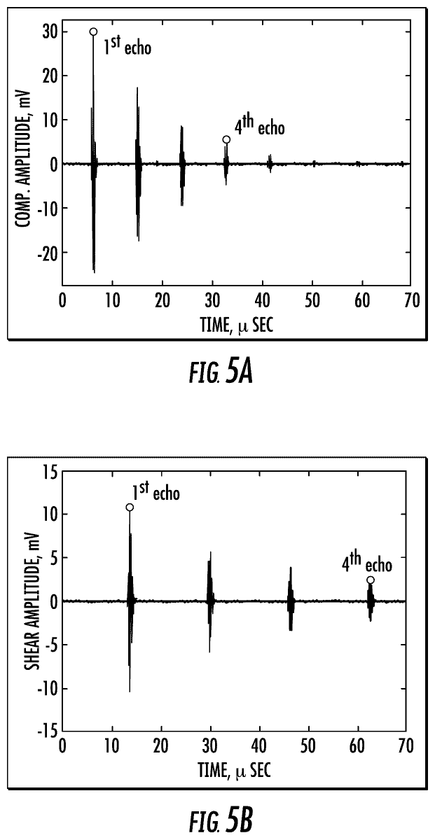

FIGS. 5A and 5B depict the acquired raw echo signals received using compressive and shear acoustic sensors, respectively. The shear pulse travels slower compared to the compressive pulse, which indicates that the shear mode can be more sensitive for TOF measurements compared to the compressive mode. Due to having a limited sampling rate (200 M samples/s) and the use of a Gaussian pulse shape with the associated relatively large pulse width, the farthest available echoes are beneficially picked to help reduce the uncertainty (e.g., potential error) in TOF measurement until the signal-to-noise ratio becomes the limiting factor. Based on the echo signal amplitudes shown in FIGS. 5A and 5B, the first and the fourth echo of each mode, as highlighted, were used to achieve the best measurement accuracy.

A smooth surface of the test sample is preferred to achieve the most reliable and accurate thickness estimate as the surface roughness of the test sample is expected to mainly affect the signal-to-noise ratio but may also lead to a significant spread of the time of arrival of the echo signal under certain conditions. The surface finish of the tested sample is 63 RMS (root mean square in microinches), which is considered an acoustically smooth surface finish since it is several orders of magnitude smaller than the acoustic wavelengths used.

For a given plate thickness, which is separately measured using a micrometer, the calculated speed of compressive (V_{c}) and shear (Vₛ) modes are 5750 m/s and 3111 m/s, respectively, at the laboratory temperature of 16.2° C. The speed is measured every 5 minutes during the calibration process, and the results are depicted as plotted in FIG. 4B. A significant difference in the temperature dependence of compressive and shear speeds is observed in FIG. 6A (both y axes have same scale butt different offsets), which indicates the different behavior of shear and compressive modes with temperature. Speed values measured only at the isothermal state are used for final calibration procedure. FIG. 6A shows the linear fit for temperature-speed relationship (i.e., the measured linear relationship between the temperature and the speed of shear and compressive modes). The linear fit for compressive mode has a slope (m_{c}) and incidence (C_{c}) of −0.77861 and 5763, respectively. Similarly, the linear fit for shear mode has a slope (mₛ) and incidence (Cₛ) of −0.71681 and 3122.6, respectively, as shown in FIG. 6A. The negative slope of both modes indicates the ultrasonic waves travel slower as the temperature of the plate increases, however, the temperature-speed slopes are different for each ultrasonic mode. The speed ratio (Vᵣ) calculated according to Equation (1) for compressive and shear modes with respect to temperature is shown in FIG. 6B (i.e., the calculated linear relationship between the temperature and the speed ratio).

$${V}_{r} = \frac{{V}_{c}}{{V}_{s}} \qquad Equation ( 1 )$$

The linear fit for speed ratio Vᵣ has a slope (mvᵣ) and incidence (cvᵣ) of 0.00017702 and 1.8456, respectively. This calibration automatically includes the temperature effects on both wave speed and physical thermal expression.

### Theoretical Formulation for Thickness Estimation

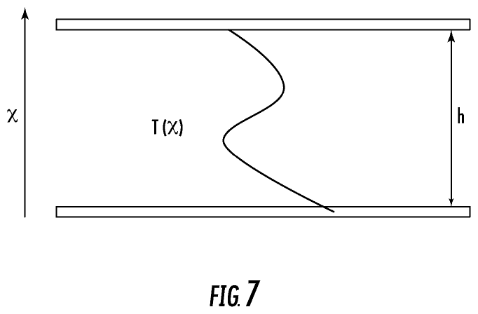

FIG. 7 is a schematic illustration of the test plate with arbitrary thermal profile T(x) and where h is the thickness of the test plate. In the presence of sub-surface thermal gradient, the temperature of the plate in the thickness direction can be represented by T(x), where x ranges from 0 to h. Ultrasonic speed in general is calculated, as shown in Equation (2). Equation (2) can be modified as Equations (3) and (4) for compressive and shear modes, respectively, where V_{avg,c} and V_{avg,s} are the average speed of compressive and shear modes, respectively. TOF_{c} and TOFₛ are the time of flight for compressive and shear ultrasonic modes, respectively. The speed of the ultrasonic waves in Equations (3) and (4) are referred to as average speeds because a non-uniform thermal profile leads to non-uniform compressive and shear speeds within the plate thickness.

$$V = \frac{2 \times h}{TOF} \qquad Equation ( 2 )$$

$${V}_{avg , c} = \frac{2 \times h}{{TOF}_{c}} \qquad Equation ( 3 )$$

$${V}_{avg , s} = \frac{2 \times h}{{TOF}_{s}} \qquad Equation ( 4 )$$

The TOF_{c} and TOFₛ are obtained experimentally using compressional and shear acoustic sensors, however, the equation systems (3) and (4) cannot be solved as they have three unknown variables, i.e., two velocities (V_{avg,c} and V_{avg,s}) and a plate thickness (h). Equation (1), from calibration, establishes an empirical relationship between two speeds (V_{avg,c} and V_{avg,s}), which provides the third equation to solve equation system. The speed ratio (Vᵣ), calculated during calibration, was conducted at an assumed isothermal condition; thus, it is important to verify whether this empirical relationship is valid under any arbitrary thermal gradient T(x), as described in Equation (5).

$${V}_{r} = \frac{{V}_{c}}{{V}_{s}} = \frac{{V}_{a vg , c}}{{V}_{avg , s}} = \frac{{TOF}_{s}}{{TOF}_{c}} \qquad Equation ( 5 )$$

The average temperature of the plate in the thickness direction at a single location is given by T_{avg}, as shown in Equation (6).

$${T}_{a v g} = \frac{1}{h} {\int }_{0}^{h} T ( x ) d x \qquad Equation ( 6 )$$

Average speed of compressive ultrasonic mode can be written as shown in Equations (7)-(9) using Equation (6) and the linear fit obtained from calibration.

$${V}_{avg , c} = \frac{1}{h} {\int }_{0}^{h} [ {m}_{c} ( T ( x ) ) + {c}_{c} ] dx \qquad Equation ( 7 )$$

$${V}_{avg , c} = {m}_{c} \frac{1}{h} {\int }_{0}^{h} ( T ( x ) ) d x + {c}_{c} \qquad Equation ( 8 )$$

$${V}_{avg , c} = {m}_{c} {T}_{a v g} + {c}_{c} \qquad Equation ( 9 )$$

Similarly, average speed of shear mode is shown in Equation (10).

$${V}_{avg , s} = {m}_{s} {T}_{a v g} + {c}_{s} \qquad Equation ( 10 )$$

It is observed from Equations (9) and (10) that the average temperature (T_{avg}) experienced by both the shear and the compressive waves are the same, and both modes have linear temperature-speed dependencies. Therefore, by solving the equation system 3-5, the plate thickness can be determined independent of any arbitrary sub-surface thermal profile.

### Experiments

The thickness estimation technique demonstrated by the theoretical formulation developed using the calibration results is validated experimentally. The thermal profile T(x) is assumed to be the same for both shear and compressive waves during theoretical formulation, thus, both sensors are kept close to each other in the experimental setup to avoid any significant temperature variation under the sensors.

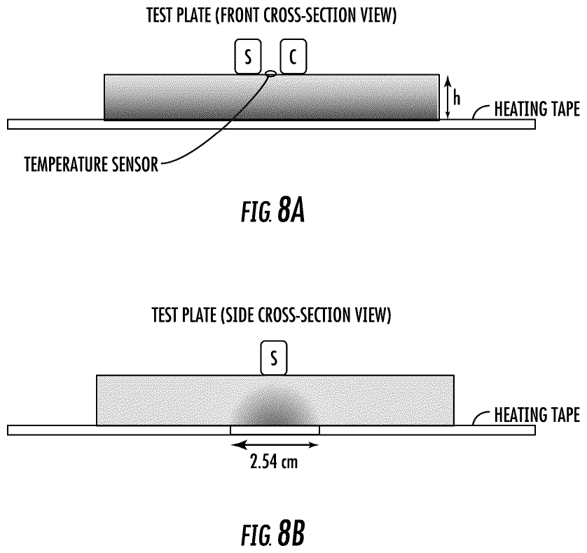

FIGS. 8A and 8B schematically depict front and side cross-section views, respectively, of the experimental setup. The data acquisition setup and calibration procedure were discussed in the Calibration section, as shown in FIG. 3. In the validation experiments, a heating tape with 2.54 cm width is placed in contact with the bottom of the test plate, right below the acoustic sensors. Temperature from the heating tape creates a subsurface thermal gradient, depicted as shading in FIGS. 8A and 8B. All the other edges and surfaces of the plate are exposed to room temperature.

There is no equilibration time between measurements and measurements are taken continuously while time-variant temperature profiles are introduced in the plate. During the validation experiments, the thermocouple attached to the bottom of the plate is not used as it is also exposed to the heating tape, and measurements from the bottom plate may not be reliable. The heating tape may not necessarily provide uniform temperature along the length of the tape.

The thickness of the plate is calculated in real time using three different techniques. The first technique is the conventional method where the test plate is assumed to be at room temperature and no temperature compensation is performed; this method is referred to as the “no compensation” method. In the “no compensation” method, Equation (2), with room temperature wave speed of any one mode, is used to calculate the plate thickness. The second method uses one acoustic sensor, and the temperature is measure from the top of the plate to estimate plate thickness. In this method, the plate is assumed to be in an isothermal condition; this method is referred to as the “1-Sensor+temp” method. In the “1-Sensor+temp” method, Equation (2), with speed corresponding to measured temperature from the top surface, is used to calculate the plate thickness with rudimentary temperature compensation.

The “2-sensor” method uses the following four steps to calculate the thickness with improved temperature compensation, notably without the need to measure temperature directly:

Step (1)—calculate the experimental speed ratio (Vᵣ) using the measured TOF from shear and compressive sensors, as shown in Equation (5).

Step (2)—using the temperature and speed ratio relationship from calibration, calculate the average temperature (T_{avg}) in the plate.

Step (3)—use T_{avg} in Equations (9) or (10) to calculate the average speed of compressive or shear ultrasonic waves, respectively.

Step (4)—obtain the thickness of the plate from the calculated shear speed.

Due to the high sensitivity of shear sensors, the “no compensation” method and the “1-Sensor+temp” method use the shear mode for thickness estimation. To ensure an unbiased comparison, shear speed is also used in Step (3) of the “2-sensor” method.

### Experiment: Continuous Heating

In a continuous heating experiment, the heating tape is turned on for about 40 minutes continuously. A steadily equilibrating thermal gradient is expected to develop in this continuous heating case.

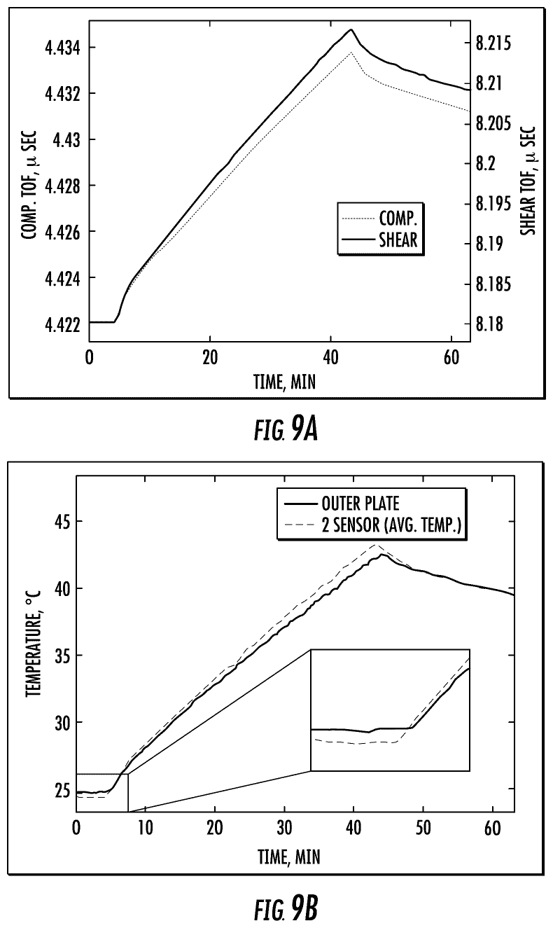

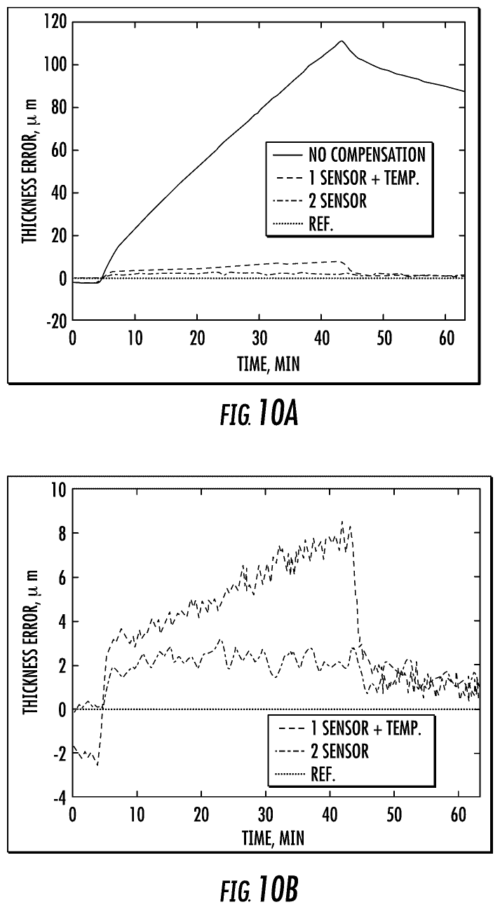

FIG. 9A depicts the measured TOF using compressive and shear sensors for a continuous heating case. A steady increase in TOF for both ultrasonic modes are noticed until the heat is turned off at approximately 43 minutes, which indicates that the ultrasonic speed reduces as the plate becomes hotter.

FIG. 9B depicts the measured temperature at the outer plate and the average temperature predicted by an example embodiment of the present disclosure by the two-sensor technique using Step (2). Throughout the heating phase (between 4 and 43 minutes), the average temperature is higher than the outer plate temperature; this is because the plate never attains isothermal condition. However, as the plate cools down (after the heat is turned off at 43 minutes), the outer plate temperature approaches the average plate temperature, indicating the plate is approaching isothermal condition. FIG. 9B includes a “zoom-in” for initial temperature estimation, in which it can be observed that the initial average temperature of the plate is slightly lower than the plate's outer surface temperatures due to the plate surface gradually heating up first as the room temperature increases. Even such minor effects that could lead to measurement errors can be successfully compensated by example embodiments of the present disclosure using the two-sensor method, as illustrated in FIGS. 10A and 10B. When the heating begins, the outer plate temperature measurement could not recognize the initiation of the heating as thermal wave takes time to reach other side of the plate. However, an example embodiment of the present disclosure with the two-sensor technique instantly identifies the heating process when it begins on the other side of the plate.

The thickness measurement for the two-sensor method is calculated as described in Step (4). The error in thickness is the difference between predicted and actual plate thicknesses (h). The thickness error for each of the no compensation” method, the “1-Sensor+temp” method, and the “2-sensor” method are illustrated in FIG. 10A. The error for the “non-compensated” method is 111 μm, which is much larger than those in the other two techniques.

FIG. 10B illustrates the “1-Sensor+temp” method and the example “2-sensor” embodiment of the present disclosure. As demonstrated in FIG. 10B, the overall performance of the example “2-sensor” embodiment of the present disclosure is significantly superior to that of the “1-Sensor+temp” method. A consistent accumulation of measurement error (maximum error of about 8 μm) is observed with the “1-Sensor+temp” method due to the increase in the build-up of sub-surface thermal gradient as the heating progresses. The example “2-sensor” embodiment of the present disclosure, being immune to sub-surface thermal gradients, shows a much smaller and constant error of about 2 μm in thickness measurement.

Accordingly, the error in thickness measurement for the “2-sensor” method in accordance with example embodiments of the present disclosure is 98% smaller than that of the “no compensation” technique and 75% lower than that of the “1-sensor+temp” technique. The measurement error noticed using the two-sensor method may possibly be due to the non-uniform temperature of the contact areas along the heating tape, which might lead to slightly different surface temperatures and thermal gradients under the shear and compressive sensors. The initial error of about 2 μm in the “1-sensor+temp” method may be due to the gradual heating of the plate surface as the room temperature increases, however, results from the two-sensor method, as illustrated in FIG. 10B, clearly demonstrate that such environmental effects are compensated successfully.

### Experiment: Intermittent Heating

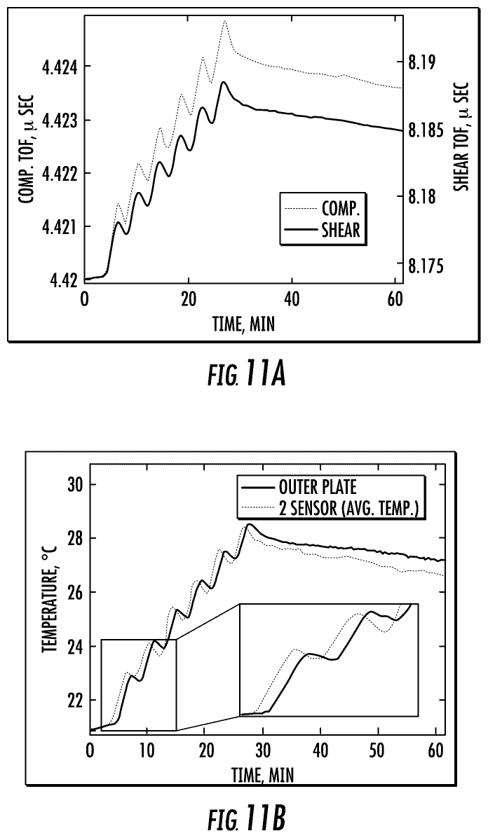

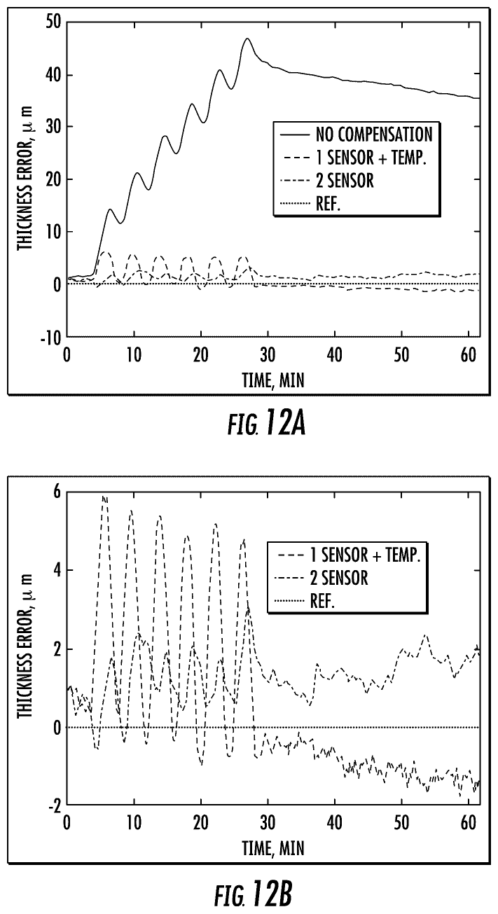

FIG. 11A illustrates the measured TOF using compressive and shear sensors in an intermittent heating experiment. FIG. 11B illustrates the measured temperature at the outer plate and the average temperature predicted by the example “2-sensor” embodiment of the present disclosure. The average temperature leads the outer plate temperature in time, indicating that the example “2-sensor” embodiment of the present disclosure tracks the heating or cooling process in real time as it occurs on the other side of the plate. FIG. 11B includes a “zoom-in” for initial temperature estimation to illustrate the performance of the example “2-sensor” embodiment of the present disclosure under rapid heating and cooling cycles. Unlike the continuous heating experiment, the outer plate temperature and average temperature do not converge to the same values instantly after final cooling phase. This effect is due to the presence of complex sub-surface thermal gradients due to intermittent heating and additional laboratory temperature drifts.

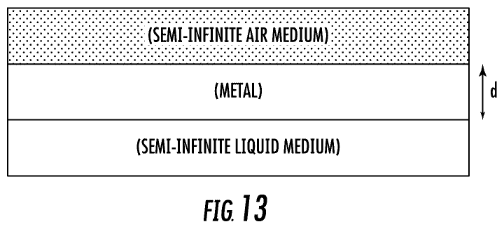

Thickness errors for each of the no compensation” method, the “1-Sensor+temp” method, and the “2-sensor” method are illustrated in FIG. 12A. The error in the “non-compensated” method increases and fluctuates greatly as the plate undergoes intermittent heating, as illustrated in FIG. 11B. FIG. 12B illustrates the “1-Sensor+temp” method and the example “2-sensor” embodiment of the present disclosure. Large variations in thickness measurements for the “1-sensor+temp” method illustrate the weakness of conventional temperature compensation techniques. Based on the results, the overall performance of the example “2-sensor” embodiment of the present disclosure is superior, especially during intermittent heating, demonstrating the ability to handle rapid temperature fluctuations.

### Example 2: Short Range Liquid Characterization

Example 2 sets forth a comprehensive analysis of acoustic guided wave modes in the container walls and their coupling to liquid contents are used to determine the optimal sensor separation distance and excitation signal characteristics, resulting in liquid level determination with high accuracy and precision. First, dispersion characteristics of guided wave propagation in container walls in contact with a liquid boundary are studied in detail. Based on the dispersion analysis, a general purpose short-range liquid level detection methodology is developed. The developed methodology is then validated using numerical wave propagation simulations and experiments on various metal containers with different physical characteristics, illustrating the versatility of the method, due to its short range and non-invasive nature.

### Dispersion Analysis for Short-Range Liquid Level Detection Methodology

Unlike bulk waves, guided waves have a strongly dispersing (i.e., frequency-dependent) characteristic, which makes their analysis more complex. Dispersion curves are powerful tools in understanding the frequency-dependent behavior of guided waves.

A global matrix method is used to model and generate dispersion curves for a container section with and without liquid boundary. As depicted in FIG. 13, guided wave propagation in a steel container wall in contact with water on one side and air on the other is modeled as a three-layer medium. With reference to FIG. 13, a three-layered model of liquid-filled container, consisting of a semi-infinite air medium, followed by the metal container with thickness ‘d’, and finally the liquid inside the container is represented as semi-infinite liquid medium. The curvature of the vessel walls are neglected during model development since the focus is on short-range detection.

A MATLAB program was used to develop a global matrix method for dispersion analysis. Pertinent material properties of the metal and liquid media used for this dispersion analysis are shown in Table 1:

TABLE 1
Material properties of the container metal
and liquid used in dispersion analysis.

| Median | Property | Value/Function | Unit |
|---|---|---|---|
| Metal (steel) | Young's modulus (E) | 210 | GPa |
| | Poission's ratio (ν) | 0.28 | — |
| | Density (ρ) | 7850 | kg/m\hat{ }3 |
| Liquid (water) | Speed of sound | 1500 | m/s |
| | Poission's ratio (ν) | 0.5 | — |
| | Density (ρ) | 1000 | kg/m\hat{ }3 |

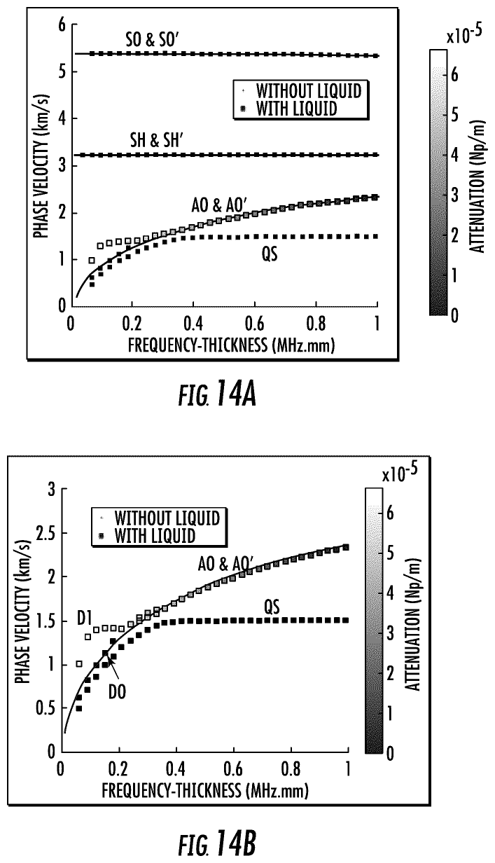

FIGS. 14A and 14B depict the generated phase-velocity versus frequency-thickness (f.d) for the steel plate loaded with and without liquid on either side. A0 and S0 are the fundamental anti-symmetric and symmetric modes, respectively, for the non-liquid loaded case, and A0‘ and S0’ represent a liquid loaded case. SH′ and SH are shear modes for liquid and non-liquid loaded case respectively. With reference to FIG. 14A, all modes under 6 km/s are displayed and with reference to FIG. 14B, all modes under 3 km/s are displayed for clarity. From FIG. 14A, it can be seen that the phase velocity and dispersion behavior of fundamental and shear modes in both cases are very similar, thus it is very difficult to detect the presence of liquid by only tracking the velocity of these modes. However, unlike a free plate, the guided wave in the liquid loaded case leaks its energy into the liquid medium and thus attenuates during propagation.

FIGS. 14A and 14B also include the attenuation of modes at different f.d combinations for the liquid loaded case. While looking at the attenuation graph in FIG. 14B, it can be inferred that A0′ is highly attenuated at low f.d and the attenuation decreases as the f.d value increases. While the energy of anti-symmetric mode A could be tracked to identify the liquid, the energy of the acquired signal is highly dependent on coupling strength. During measurement, conventional portable or sliding probe techniques generally exhibit varying acoustic coupling strength with containers, thus making the use of the absolute magnitude of any specific mode unreliable for liquid detection. This example on the other hand monitors relative strength change among multiple modes and the presence of the QS mode to identify the presence of liquid.

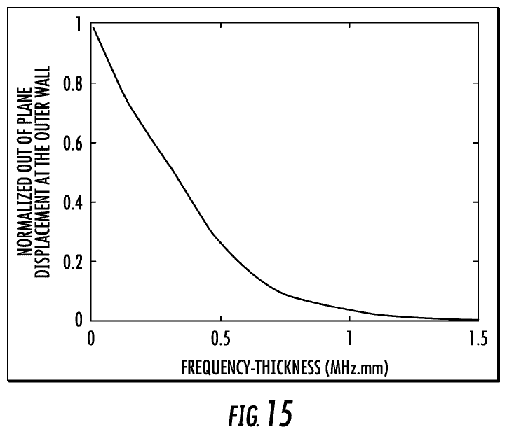

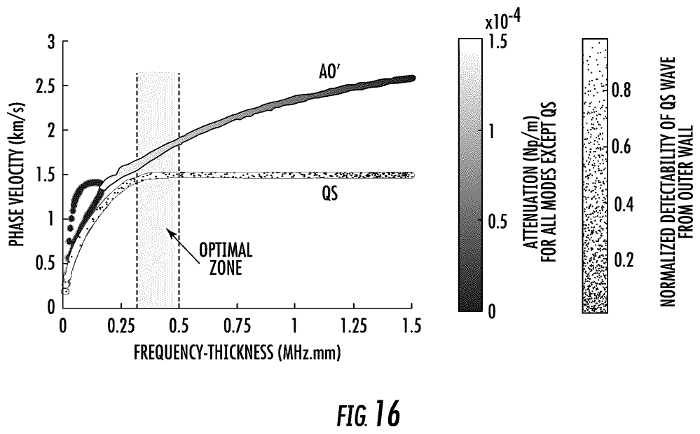

With reference to FIG. 14B, the presence of D0, D1, and Quasi-Scholte (QS) waves in the liquid-loaded case are observed. Modes D0 and D1 are not used for liquid detection here because they are highly dispersive and possess phase velocities that are very similar to that of the A0 mode. Tracking the presence of the QS mode may be the best method for liquid detection, because they are not dispersive at sufficiently high f.d values (in this example, at f.d values above 0.3 MHz.mm) and possess phase velocities that are significantly different from the A0 mode. However, detection of QS wave from the outer wall is not possible at all f.d combinations. Based on wave structure analysis, FIG. 15 illustrates the out-of-plane displacement of QS mode at the outer wall of the container for different f.d values. It can be seen that the QS mode is highly detectable (maximum out-of-plane displacement) in the outer wall surface at very low f.d values and it is nearly undetectable (very small out-of-plane displacement) as the f.d approaches 1 MHz.mm. FIG. 16 illustrates the attenuation of all modes except QS and detectability of QS from the outer wall surface. While operating at f.d values below 0.3 MHz.mm, the phase velocities for QS and A0 modes are nearly equal (see e.g., FIGS. 14A and 14B), which may lead to misinterpretation of liquid presence. Operating beyond 0.5 MHz.mm will lead to appearance of A0′ and disappearance of QS on the outer wall as a result of the energy of QS mode being concentrated at the inner wall interface as the f.d value increases. Thus, an optimal zone of f d values are indicated in FIG. 16, which is the proposed zone for the reliable detection of liquid. By operating the transmitter within the optimal frequency zone, the detection of QS mode by the receiver in the presence of liquid may be ensured.

Accordingly, two important statements can be made for the case where the excitation frequency is within the optimal zone: (1) A0′ diminishes and QS appears in the presence of liquid; and (2) [symbol] S disappears and A0 strengthens in the absence of liquid. Equation (11) provides for automated liquid detection based on these statements.

$${QS}_{max} - {A}_{max} \qquad Equation 11$$

where [symbol] Sₘₐₓ is the maximum amplitude of Quasi-Scholte mode after normalizing with respect to the maximum received signal amplitude. Aₘₐₓ is the maximum amplitude of anti-symmetric mode (A0 or A0′) after normalization. D is the liquid detectability parameter which takes a value between −1 and +1. When the value of D is positive it indicates the presence of liquid, and conversely a negative value of D indicates the absence of liquid.

### Numerical Simulations

A finite element (FE) wave propagation simulation on containers with and without liquid are performed. Simulation results are used to numerically verify the analytical results on the behavior of guided wave modes and the liquid detection method developed in the Dispersion Analysis for Short-Range Liquid Level Detection Methodology section. Simulations are performed using COMSOL MULTIPHYSICS 5.6, a commercial FE software.

### Numerical Simulations: Simulation Setup

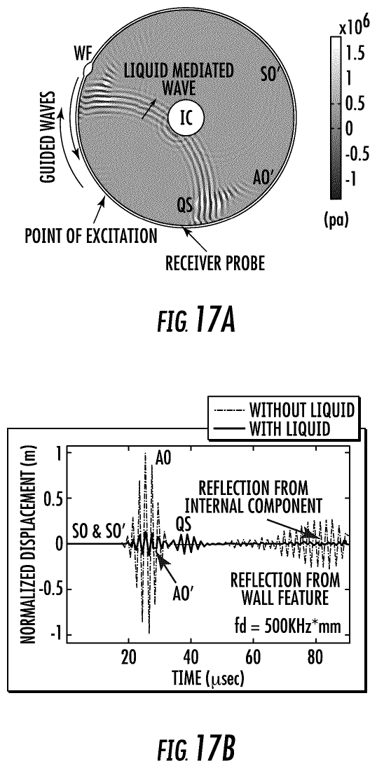

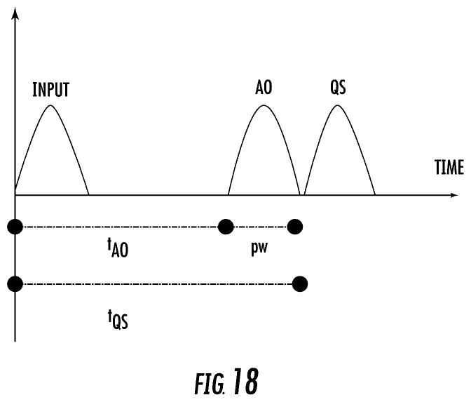

For simulation purposes, a two-dimensional (2D) cross-section of a cylindrical steel container with 12 cm diameter and 1 mm wall thickness is considered. The geometry also includes a wall feature (WF) and an internal component (IC) placed at the center of the container as depicted in FIG. 17A. Two simulations are performed, one with the presence of liquid and the other without liquid medium. Material properties of steel and liquid are listed in Table 1. Since the physics involved in the wave propagation of metals and fluids are different, a multi-physics simulation is utilized. A time explicit pressure acoustic model is used to capture the propagating wave in the liquid medium and a time explicit elastic wave model is used for the metal. Both physics models are coupled by using an acoustic-structure boundary pair at the inner wall and at the outer boundary of internal component. Both metal and liquid medium are meshed with triangular elements with a size control to achieve at least 10 elements for the selected wavelength of S0 mode. Excitation frequency is selected as discussed in the Dispersion Analysis for Short-Range Liquid Level Detection Methodology section. For this simulation, 0.5 MHz.mm is chosen so the existences of both the A0′ and [symbol] S modes can be seen. To simulate the excitation, a Gaussian pulse with centre frequency of 0.5 MHz with 0.5 bandwidth (fractional bandwidth in frequency domain of pulse) is prescribed as point velocity input as shown in FIGS. 17A and 17B. Simulations are conducted for 90 μsec with a physics-controlled time step. After analyzing the phase velocity of A0′, S0′ and [symbol] S modes, the receiver probe and point of excitation are separated at a circumferential distance of 4.6 cm to ensure the modes are distinguishable. A wall feature (weld seam) is set at a circumferential distance of 7 cm from the point of excitation.

### Numerical Simulations: Simulation Results

FIG. 17A depicts the pressure field for the ultrasonic wave propagation in the liquid filled container at 45 μsec. The pressure field inside the liquid medium clearly indicates the energy loss from each mode and the liquid mediated wave travelling to the opposite side of the excitation source. Reflections form the wall feature and the internal component are additionally illustrated in FIGS. 17A and 17B. The numerically simulated pressure fields of fundamental modes clearly support the analytically obtained attenuation behavior described in the Dispersion Analysis for Short-Range Liquid Level Detection Methodology section. With reference to FIG. 16 at 0.5 MHz.mm, the symmetric S0′ mode exhibits lower attenuation compared to the A0′ mode. This behavior is seen in the pressure field, where the energy leaked into the liquid medium from the propagating A0′ mode is very strong compared to the S0′. FIG. 17A also reflects the [symbol] S mode traveling at a velocity of 1500 m/s behind A0′. Reflected guided waves and liquid mediated waves from wall feature and internal component can be visualized in the pressure field plot.

A receiver probe along the outer wall of the container measures the out-of-plane displacement due to the propagating guided waves. FIG. 17B illustrates the measured normalized displacement against simulation time. The reduced amplitude of fundamental modes (A0′) for liquid-filled cases indicates significant energy leakage into the liquid medium. The presence of liquid can be clearly identified by the presence of [symbol] S mode in the liquid filled case. FIG. 17B also illustrates the reflected guided wave and liquid mediated wave from the wall feature and internal component, respectively. Since [symbol] S is the primary liquid detection mode, sensors should be deployed carefully to avoid any interference of reflected waves with [symbol] S mode.

Referring to FIG. 15, detectability of [symbol] S mode can be improved by exciting at low f.d combination within the optimal frequency zone. However, a lower frequency selection will require larger separation distance between excitation and receiver probes to temporally separate the wave packets from each mode. Separation distance between sensors is also chosen depending on the bandwidth of excitation frequency. A narrow band excitation can help to reduce the dispersion of A mode, however, in that case a larger ds is required to clearly identify the, [symbol] S wave packet. It is important to temporally separate [symbol] S and A0 modes for successful liquid detection as shown in FIG. 18. Thus, the time of arrival of [symbol] S mode should be equal or greater than, the time of arrival of A0 mode plus the Gaussian pulse width of A0 mode, which is mathematically represented by Equation (12)

$${t}_{Q S} \geq p w + {t}_{A 0} \qquad Equation ( 12 )$$

where pw is the Gaussian pulse width of A0 mode; t [symbol] _{S} and t_{A0} are the arrival time of [symbol] and A0 mode, respectively. Using time-distance-velocity relation, Equation (12) can be rearranged to obtain required sensor separation distance ds in Equation (13)

$$d s \geq \frac{n c}{f} \times \frac{{V}_{Q S} \times {V}_{A 0}}{{V}_{A 0} - {V}_{Q S}} \qquad Equation ( 13 )$$

where nc is the Gauss pulse width pw for selected number of cycles nc and excitation frequency f; V [symbol] _{S} and V_{A0} are the velocities of [symbol] S and A0 mode at the selected frequency f. Notably, dispersion of the A0 mode is not accounted for during ds estimation.

### Experiments

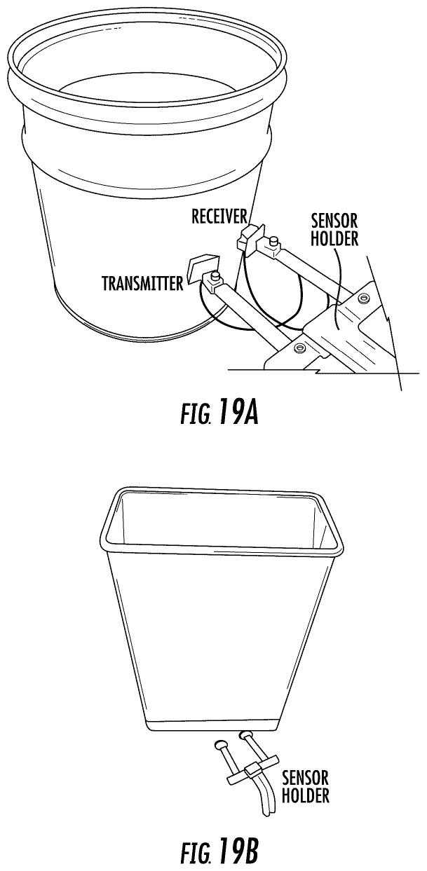

A short-range method in accordance with various embodiments of the present disclosure is experimentally validated on open metal containers without any internal components. Two containers with different shapes and sizes are experimentally tested: a cylindrical 5-gallon steel pail as illustrated in FIG. 19A and a cuboid shaped 22-gallon steel container as illustrated in FIG. 19B. The cylindrical pail has a diameter of 29 cm and wall thickness of 0.6 mm. The cuboid shaped container has outer dimensions of 75 cm×53 cm×28 cm (height×width×depth), with a wall thickness of 0.6 mm. The metal and liquid used for these tests were identical to those used in the simulation and dispersion study listed in Table 1. The present disclosure contemplates that the non-invasive short-range technique in accordance with various embodiments of the present disclosure is also applicable to closed containers, containers with internal components, and containers made of other solid materials, such as specialty metal alloys, glasses, or ceramics.

### Experiments: Experimental Setup

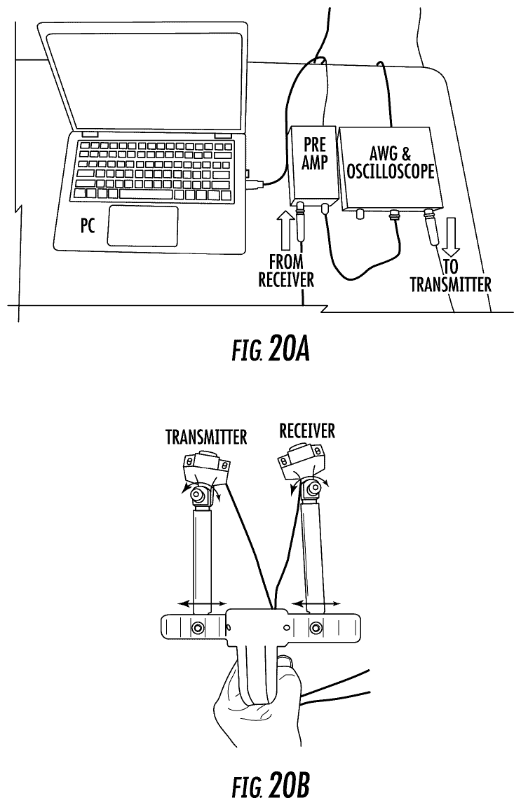

FIGS. 20A and 20B show the experimental setup consisting of data acquisition (DAQ) system and the sensor holder. The acoustic liquid level detection system consists of four major components:

(1) A laptop with Python interface to control the DAQ system.

(2) Tie-Pie (model: HS5) DAQ unit equipped with arbitrary waveform generator (AWG) and oscilloscope.

(3) A pre-amplifier (model: 5660B; Olympus, Inc.) with a cut-off frequencies of 20 KHz and 2 MHz.

(4) Two transducers (Model: V103-RM; Olympus, Inc.) with centre resonant frequency of 1 MHz. These sensors perform reasonably well within 200 kHz and 1.2 MHz. V-103 as a compressional transducer senses out-of-plane displacement of all traveling modes, including modes of interest to this experiment, such as A0, S0, and [symbol] S modes. The sensor holder used to perform experimental validation of the methodology was fabricated using stereolithographic additive manufacturing (SLA). The SLA printer used for this work was a Form3+from Formlabs. Clear resin was used to fabricate the parts, and post-processing was performed at 60° C. for 15 minutes, as suggested by the manufacturer. The 3D printed sensor holder is designed to have an adjustable sensor separation ranging from 5 cm to 15 cm. Further, the sensors can be tilted to accommodate most 269 curved container walls as shown in FIG. 20B. AWG is used to send a Gaussian pulse of selected central frequency to transmitter which introduces liquid mediated and primary guided acoustic waves into the container. Propagating primary guided wave is acquired by the receiver placed at a distance of 7 cm from transmitter for the cylindrical pail and 15 cm for the cuboid shaped container. Probe separations are measured from the center of the transducers. Acquired signals from the receiver were amplified using a pre-amplifier and sampled at a rate of 0.5 MS/s.

### Experiments: Results and Discussion

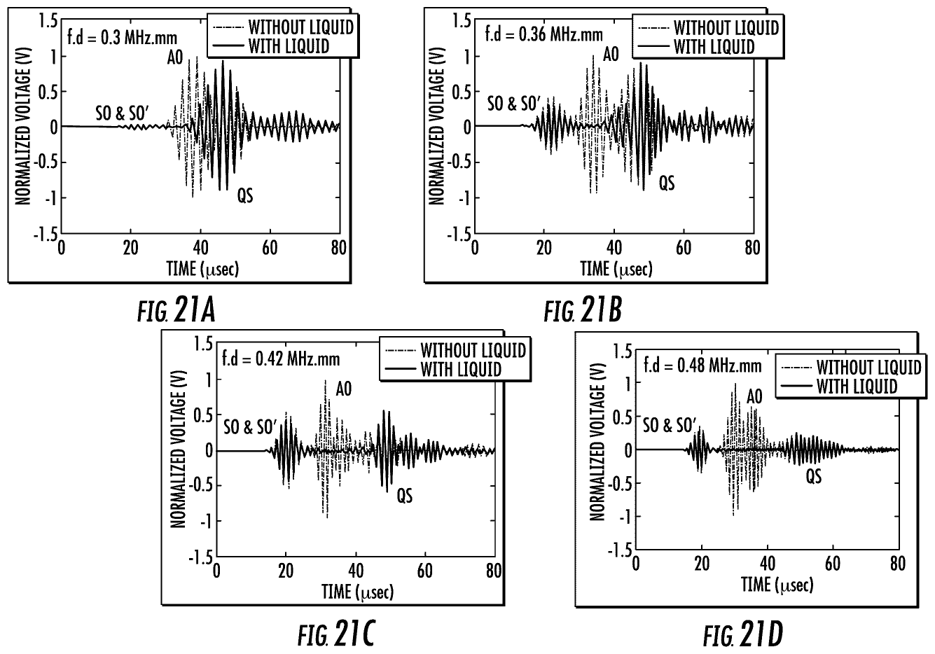

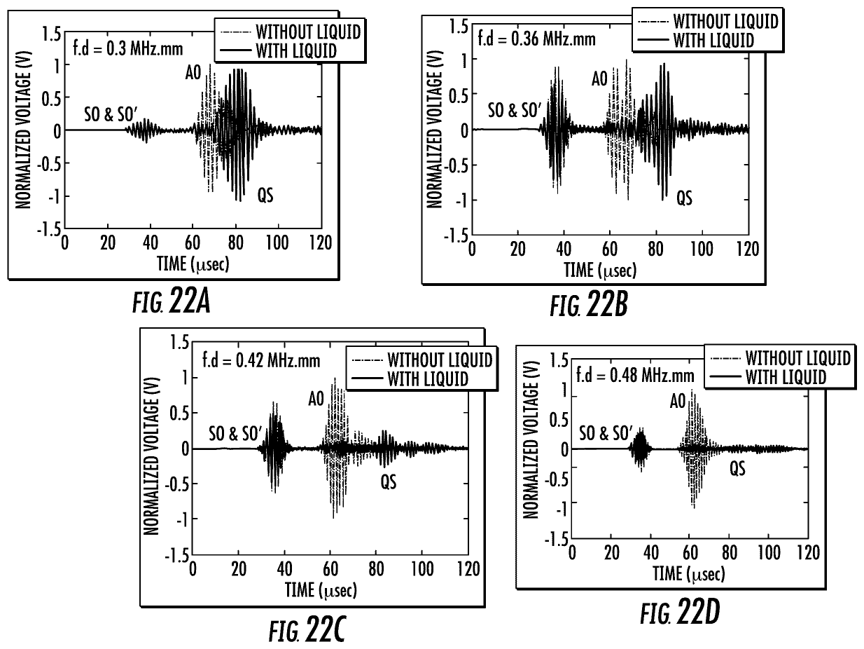

Based on the detectability and attenuation studies described in the Dispersion Analysis for Short-Range Liquid Level Detection Methodology section, FIG. 16 shows the optimal f.d choices for any steel container. For the selected cylindrical steel pail and cuboid shaped steel container with wall thickness of 0.6 mm, an excitation frequency of 500, 600, 700, and 800 kHz corresponding to an f.d value of 0.3, 0.36, 0.42, and 0.48 MHz.mm are selected, respectively. FIGS. 21A-21D present the normalized voltage acquired by the receiver with and without liquid for 80 μsec from the time of excitation for the cylindrical pail. Similarly, FIG. 22A-22D presents the normalized voltage acquired by the receiver with and without liquid for 120 μsec from the time of excitation for the cuboid shaped container.

Acquired signals are normalized with respect to the maximum voltage among signals received with and without liquid for each excitation frequency. This normalization is performed to help with the visualization of the relative change in amplitude of [symbol] S mode. Referring to FIGS. 21A-21D and 22A-22D, each mode is discussed in detail. First, symmetric modes with and without liquid (S0 and S0′) have a very similar amplitude and time of flight. This observation experimentally validates the dispersion and attenuation in the Dispersion Analysis for Short-Range Liquid Level Detection Methodology section. Further, simulation results in FIGS. 17A and 17B also confirm a negligible leakage of energy from the symmetric mode to the liquid medium. Secondly, with reference to FIGS. 21A-21D and 22A-22D, the antisymmetric mode in the acquired voltage without the presence of liquid (A0) is clearly identifiable at all excitation frequencies. In the presence of liquid, the antisymmetric mode attenuates heavily by leaking its energy into the liquid medium. This attenuation behavior is in accordance with simulation results shown in FIGS. 14B and 17A, respectively. Finally, the [symbol] S mode is the slowest mode that travels behind A0′ with an energy velocity of 1500 m/s. Based on the dispersion study, this mode can be seen only in the presence of liquid and the energy concentrates along the metal-liquid interface as the f.d value increases. With reference to FIGS. 21A-21D and 22A-22D, it is clear that the [symbol] S mode is present only in the presence of liquid and the amplitude of [symbol] S mode measured from the outer wall gradually decreases as the f.d value increases.

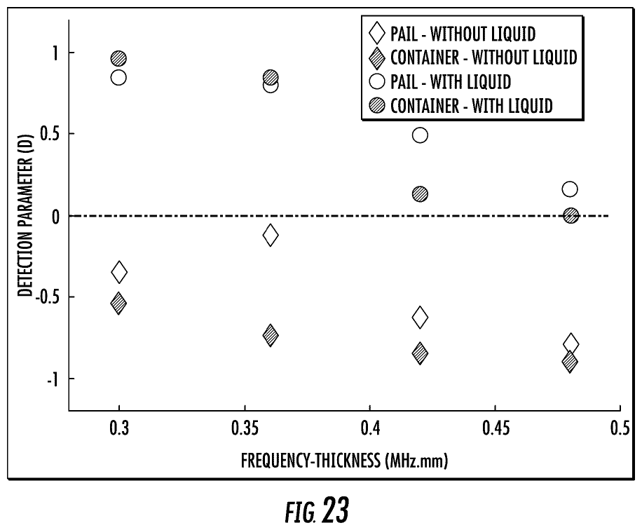

Presence of the [symbol] S mode is the key liquid detection factor. As a general rule, [symbol] S modes are excited when liquid is present on the other side of the container wall directly across from the attached sensor. Thus, liquid levels are detected with an accuracy of +/−half the diameter of the transducer. Acquired signals from the steel pail and container show notable differences despite their material properties and wall thicknesses being similar. This is due to two major factors: (1) the curvature in the cylindrical steel pail creates a line contact between circular transducer and pail, whereas a full areal contact is established in the flat container, and (2) the probe separation distances are different for the two experiments. Nevertheless, Equation (11) is applied in each case for automated liquid detection. FIG. 23 illustrates the value of D calculated for each acquired signal. The value of D is positive for liquid filled cases and negative for containers without liquid. With reference to FIG. 22D, the detection value of the container with liquid at 0.42 and 0.48 MHz.mm approaches zero, which is due to the diminishing amplitude of the [symbol] S mode at the outer wall at large f.d values. The D value of the pail without liquid at 0.36 MHz.mm is close to zero due to the dispersion of A0 mode; this issue can be resolved readily by having slightly larger probe separation distance than the one implemented in this Example 2. In general, a larger probe separation distance will help better distinguish the wave pockets temporally. Choosing an optimal probe separation distance is discussed in given in the Experiment: Optimal Probe Separation Distance section.

Accordingly, all three modes observed during the experiments further validate the analytical and simulation studies, and consequently, the applicability of the short-range method in accordance with various embodiments of the present disclosure. For example, in accordance with one short-range method embodiment, (1) identify a short range measurement zone away from major container features for sensor placement, (2) obtain wall thickness and material properties of container wall and liquid medium, (3) obtain dispersion curves in the presence of liquid as shown in FIG. 16, and (4) identify the optimal sensor separation (ds) and optimal excitation frequency for liquid level detection. The present disclosure contemplates that short-range methods in accordance with various embodiments of the present disclosure are applicable to containers with various shapes, sizes, and wall thicknesses, including closed containers and any solid-wall material, including specialty metal alloys, ceramics, or glass.

### Optimal Probe Separation Distance

Optimal sensor separation value ds is obtainable with an approximate knowledge of container dimension and material and liquid properties. Once the ds value is obtained, the following three conditions should be met to ensure the most favorable applicability of this technique on the selected container:
(1) Selected ds value should be smaller than dsₘₐₓ.
(2) Circumferential distance between the transmitter and any closest wall feature should be greater than xₘᵢₙ.
(3) The absolute distance between the transmitter and any closest internal component should be greater than ds.
where dsₘₐₓ and xₘᵢₙ are the maximum sensor separation distance and minimum distance between transmitter and any wall feature, respectively. These values are obtained based on the container dimensions and acoustic velocities as shown in Equations (14) and (15).

$$d {s}_{max} = \frac{2 r {V}_{S G W} + π {rV}_{Q S}}{{V}_{S G W} + {V}_{Q S}} \qquad Equation ( 14 )$$

$${x}_{min} = \frac{d s}{2} ( \frac{{V}_{G W}}{{V}_{Q S}} - 1 ) \qquad Equation ( 15 )$$

where r is the radius of the container; ds is the circumferential distance between the sensors; V_{GW} and V_{SGW} are the velocities of the fastest mode in the primary and secondary guided wave respectively; [symbol] is the velocity of [symbol] S mode in primary guided wave. A discussion of how to obtain dsₘₐₓ and xₘᵢₙ is set forth in the Example 3: Short Range Liquid Characterization section.

Table 2 shows the optimal frequency range and applicability parameters ds and xₘᵢₙ calculated for three typical containers with different sizes and materials.

TABLE 2
Calculated applicability parameters and optimal
frequency range for steel and glass containers.

| | Optimal | | |
|---|---|---|---|
| | frequency range | | |
| Container | [MHz] | [symbol] | [symbol] |
| [symbol] glass bottle | 0.3-0.5 | 7.9 | 11.5 |
| Material: glass | | (at f [symbol] 0.4 MHz | |
| Diameter: 10 cm | | and [symbol] 5) | |
| Wall Thickness: 1 mm | | | |
| Content: water | | | |
| 5 Gal. steel pail | 0.5-0. [symbol] 3 | 6.7 | 8.3 |
| Material: steel | | (at f [symbol] 0.7 MHz | |
| Diameter: 29 cm | | and [symbol] 5) | |
| Wall Thickness: 0.6 mm | | | |
| Content: water | | | |
| 55 Gal. steel drum | 0.3-0.5 | 11.7 | 14.5 |
| Material: steel | | (at f [symbol] 0.4 MHz | |
| Diameter: 5 [symbol] .4 cm | | and [symbol] 5) | |
| Wall Thickness: 1 mm | | | |
| Content: water | | | |

[symbol]

indicates data missing or illegible when filed

The error in liquid level detection using this method depends on the sensor contact area. When the sensor contact surface to the outer wall is partially above and partially below the liquid level then both [symbol] S and A0 modes could be generated. Further, depending on how the user applies pressure, the intensity of [symbol] S and A0 modes could change. Thus, conservatively, the measurement is reliable only when the sensor is completely above or below the liquid level. Thus, the maximum possible error in level detection is the diameter of the sensor used. Therefore, the smaller the sensor diameter, the better the accuracy of level detection at the expense of decreased signal amplitude. Volume resolution (VR) for any container with radius (r) and sensor diameter (d) is calculated as shown in Equation (16).

$$VR = π {r}^{2} \times d \qquad Equation ( 16 )$$

Volume resolution for three common containers using OLYMPUS V103-RM and ULTRAN WC25-1 sensors are shown in Table 3 along with corresponding error % in liquid volume.

TABLE 8
Calculated volume resolution for steel and glass containers
using OLYMPUS V103-RM and ULTRAN WC25-1 sensors.

| Container | Sensor | Volume resolution (cm³) and error % |
|---|---|---|
| 1 L glass bottle | Olympus | 102.1 (10.2%) |
| Material: glass | V103-RM | |
| Diameter: 10 cm | Diameter = 13 mm | |
| | Ultran | 49.5 (4.9%) |
| | WC25-1 | |
| | Diameter = 6.3 mm | |
| 5 Gal Steel Pail | Olympus | 858.7 (4.54%) |
| Material: Steel | V103-RM | |
| Diameter: 29 cm | Diameter = 13 mm | |
| | Ultran | 416.1 (2.2.96) |
| | WC25-1 | |
| | Diameter = 6.3 mm | |
| 55 Gal Steel drum | Olympus | 3484.6 (1.7%) |
| Material: Steel | V103-RM | |
| Diameter: 58.4 cm | Diameter = 13 mm | |
| | Ultran | 1688.7(0.81%) |
| | WC25-1 | |
| | Diameter = 6.3 mm | |

### Example 3: Short Range Liquid Characterization

### Demonstration of Short-Range Liquid Level Detection

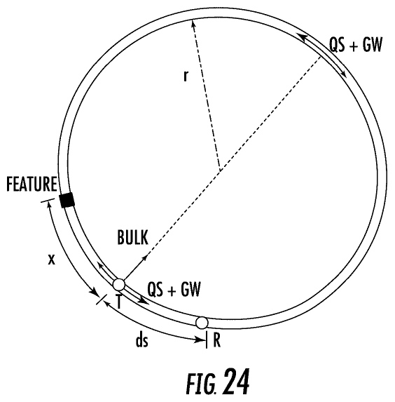

FIG. 24 schematically illustrates a short-range detection method in accordance with various embodiments of the present disclosure on a cylindrical container with a wall feature and secondary guided waves (SGW). SGW can be disregarded for a large container, however, for small containers, SGW could interfere with the detection technique. To avoid the interference of SGW, the time of flight (TOF) of SGW (TOF_{SGW}) to the receiver (R) must be greater than the TOF of [symbol] S mode (TO [symbol] ).

TOF_{SGW} and TO [symbol] for a cylindrical container with radius r are given in Equation (17) and receiver (R); V_{SGW} and [symbol] are the velocities of the fastest mode in SGW and QS mode, respectively.

$${TOF}_{S G W} = \frac{2 r}{{V}_{Q S}} + \frac{π r - d s}{{V}_{S G W}} \qquad Equation ( 17 )$$

$${TOF}_{Q S} = \frac{d s}{{V}_{Q S}} \qquad Equation ( 18 )$$

Maximum value for ds is obtained by equating and solving Equations (17) and (18).

$$d {s}_{max} = \frac{2 r {V}_{S G W} + π {rV}_{Q S}}{{V}_{S G W} + {V}_{Q S}} \qquad Equation ( 19 )$$

If the required transducer separation ds is greater than dsₘₐₓ, then the selected container may be too small.

Most containers possess features such as weld seems or attachments on the wall and guided wave reflections from these features may affect the liquid detection. The minimum distance xₘᵢₙ between a closest feature and transmitter to avoid interference shall be obtained by equating the arrival time of reflection from the feature (TOFₓ) and arrival time of [symbol] S mode (TO [symbol] ) to the receiver (R), where V_{GW} is the velocity of fastest mode in primary guided wave.

$${TOF}_{x} = \frac{2 x}{{V}_{G W}} + \frac{d s}{{V}_{G W}} \qquad Equation ( 20 )$$

$${x}_{min} = \frac{d s}{2} ( \frac{{V}_{G W}}{{V}_{Q S}} - 1 ) \qquad Equation ( 21 )$$

Accordingly, in case of containers with internal components, the distance between any closest internal components and the transmitter must be greater than ds to avoid interference.

Thus, particular embodiments of the subject matter have been described. While this specification contains many specific implementation details, these should not be construed as limitations on the scope of any embodiments or of what may be claimed, but rather as description of features specific to particular embodiments of the present disclosure. Other embodiments are within the scope of the following claims. It is evident that many alternatives, modifications, and variations will be apparent to those skilled in the art in light of the foregoing description. It is therefore contemplated that the appended claims will embrace any such alternatives, modifications, and variations as falling within the scope and spirit of the present disclosure.

Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while steps or processes are depicted in the drawings in a particular order, this should not be understood as requiring that such steps or processes be performed in the particular order shown or in sequential order, or that all illustrated steps or processes be performed, to achieve desirable results, unless described otherwise. Said differently, the actions recited in the claims can be performed in a different order and still achieve desirable results. In addition, the processes depicted in the accompanying figures do not necessarily require the particular order shown, or sequential order, to achieve desirable results, unless described otherwise. In certain implementations, multitasking and parallel processing may be advantageous.

### Overview of Terms

For the purposes of the present application, the following explanations of terms are provided to better describe the present disclosure and to guide those of ordinary skill in the art in the practice of the present disclosure:

As used herein, the term “comprising” means including but not limited to and should be interpreted in the manner it is typically used in the patent context. Use of broader terms such as “comprises”, “includes”, and “having” should be understood to provide support for narrower terms such as “consisting of”, “consisting essentially of”, and “comprised substantially of”.

As used herein, the phrases “in one embodiment,” “according to one embodiment,” “in some embodiments,” and the like generally refer to the fact that the particular feature, structure, or characteristic following the phrase may be included in at least one embodiment of the present disclosure. Thus, the particular feature, structure, or characteristic may be included in more than one embodiment of the present disclosure such that these phrases do not necessarily refer to the same embodiment.

As used herein, the phrases “based on,” “based at least in part on,” “based at least on,” “based upon,” and the like are used herein interchangeably in an open-ended manner such that they do not indicate being based only on or based solely on the referenced element or elements unless so indicated.

As used herein, the terms “illustrative,” “example,” “exemplary” and the like are used to mean “serving as an example, instance, or illustration” with no indication of quality level. Any implementation described herein as “exemplary” or “example” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

The terms “about,” “approximately,” “generally,” “substantially,” or the like, when used with a number, may mean that specific number, or alternatively, a range in proximity to the specific number, as understood by persons of skill in the art field and may be used to refer to within manufacturing and/or engineering design tolerances for the corresponding materials and/or elements as would be understood by the person of ordinary skill in the art, unless otherwise indicated.

It is understood that where a parameter range is provided, all integers and ranges within that range, and tenths and hundredths thereof, are also provided by the embodiments. For example, “5-10%” includes 5%, 6%, 7%, 8%, 9%, and 10%; 5.0%, 5.1%, 5.2% . . . 9.8%, 9.9%, and 10.0%; and 5.00%, 5.01%, 5.02% . . . 9.98%, 9.99%, and 10.00%, as well as, for example, 6-9%, 5.1%-9.9%, and 5.01%-9.99%. Similarly, where a list is presented, unless stated otherwise, it is to be understood that each individual element of that list, and every combination of components of that list, is a separate embodiment. For example, “1, 2, 3, 4, and 5” encompasses, among numerous embodiments, 1; 2; 3; 1 and 2; 3 and 5; 1, 3, and 5; and 1, 2, 4, and 5.

The term “plurality” refers to two or more items.

The term “set” refers to a collection of one or more items.

The term “or” is used herein in both the alternative and conjunctive sense, unless otherwise indicated.

### CONCLUSION

Many modifications and other embodiments of the present disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. An acoustic measurement system comprising:
a container comprising a container wall structurally defining an internal cavity of the container;
a process fluid disposed within the internal cavity;
a first acoustic sensor coupled to an external surface of the container wall; and
a second acoustic sensor coupled to the external surface of the container wall, the first and second acoustic sensors configured to emit ultrasonic waves according to different modalities, wherein, in operation, the system is configured to compensate for temperature in near real-time to acoustically determine container wall thickness measurements.

2. The acoustic measurement system of claim 1, wherein the first acoustic sensor is a shear acoustic sensor configured to emit ultrasonic waves in a shear mode.

3. The acoustic measurement system of claim 2, wherein the second acoustic sensor is a compressive acoustic sensor configured to emit ultrasonic waves in a compressive mode.

4. The acoustic measurement system of claim 1, wherein a standoff is disposed between the wall and at least one of the first acoustic sensor and the second acoustic sensor.

5. The acoustic measurement system of claim 1, wherein at least one of the first acoustic sensor and the second acoustic sensor comprises radiation shielding.

6. The acoustic measurement system of claim 1, wherein the container is a flow pipe.

7. The acoustic measurement system of claim 1, wherein the container is a vessel of irregular shape.

8. The acoustic measurement system of claim 1, wherein the container comprises one or more internal components.

9. The acoustic measurement system of claim 8, wherein the one or more internal components comprise at least one of a mixing element, wave breaker, splash plate, or sand trap.

10. The acoustic measurement system of claim 1, wherein the container wall comprises a specialty metal alloy, stainless steel, glass, or ceramic.

11. A non-invasive acoustic measuring method comprising:
coupling a first acoustic sensor and a second acoustic sensor to an external surface of a container wall, wherein the first acoustic sensor and the second acoustic sensor are configured to emit ultrasonic waves in different modalities;
calculating a speed ratio (Vᵣ) of the first and second acoustic sensors;
determining an average temperature (T_{avg}) of the container wall;
calculating an average speed of the ultrasonic waves of at least one of the first acoustic sensor or the second acoustic sensor, wherein the average speed of the ultrasonic waves is based at least in part on the determined average temperature (T_{avg}) in the container wall; and
determining a thickness of the container wall based at least in part on the calculated ultrasonic wave speed.

12. The method of claim 11, wherein the first acoustic sensor is a shear acoustic sensor and the second acoustic sensor is a longitudinal or compressive acoustic sensor.

13. The method of claim 12, wherein calculating the speed ratio (Vᵣ) of the first and second acoustic sensors comprises:
measuring time of flight (TOF) for each of the shear acoustic sensor (TOFₛ) and the compressive acoustic sensor (TOF_{c}); and
determining the speed ratio (Vᵣ) based on Equation (5):
$${V}_{r} = \frac{{V}_{c}}{{V}_{s}} = \frac{{V}_{avg , c}}{{V}_{avg , s}} = \frac{{TOF}_{s}}{{TOF}_{c}} . \qquad Equation ( 5 )$$

14. The method of claim 12, wherein determining the average temperature (T_{avg}) of the container wall is based on a calculated linear relationship between the container wall temperature and the speed ratio.

15. The method of claim 12, wherein calculating the average speed of the ultrasonic waves of the shear acoustic sensor is based on Equation (10):
$${V}_{avg , s} = {m}_{s} {T}_{a v g} + {c}_{s} . \qquad Equation ( 10 )$$

16. The method of claim 12, wherein calculating the average speed of the ultrasonic waves of the compressive acoustic sensor is based on Equation (9):
$${V}_{avg , c} = {m}_{c} {T}_{a v g} + {c}_{c} . \qquad Equation ( 9 )$$

17. The method of claim 12, further comprising:
determining a required sensor separation distance; and
coupling a third acoustic sensor to the external surface of the container wall, wherein the second and third acoustic sensors are separated by the required sensor separation distance.

18. A nondestructive method for characterization of short-range wall properties, the method comprising:
coupling at least a first acoustic sensor and a second acoustic sensor to an external surface of a container wall;
exciting a guided acoustic wave that is generated by the first acoustic sensor and received by the second acoustic sensor, wherein the guided acoustic wave interacts with a short-range wall section of the container wall as the guided acoustic wave travels between the two acoustic sensors; and
determining property information about the short-range wall section based at least on the interactions of the guided acoustic wave with the short-range wall section of the container wall.
